(19) United States
(12) Patent Application Publication
(10) Pub. No.: US 2011/0125575 A1
(43) Pub. Date: May 26, 2011

(54) Method and Apparatus for Providing Multiple Advertisers' Offers in a Single Banner

(75) Inventors: Zephrin I. Lasker, Brooklyn, NY (US); Roshan B. Bangera, Brooklyn, NY (US); Geoffrey B. Grauer, Brooklyn, NY (US); Nicholas P. Herman, Brooklyn, NY (US)

(73) Assignee: PONTIFLEX, INC., Brooklyn, NY (US)

(21) Appl. No.: 12/947,675

(22) Filed: Nov. 16, 2010

Related U.S. Application Data
(60) Provisional application No. 61/263,250, filed on Nov. 20, 2009.

(51) Int. Cl. G06Q 30/00

(52) U.S. Cl. 705/14.53; 705/14.55

(57) ABSTRACT

One or more embodiments of the present invention relate to method and apparatus for displaying multiple Advertisers' offers within a single banner Ad Unit, and for collecting consumers' responses and self-reported personal information within that Ad Unit.

### CROSS-REFERENCE TO RELATED APPLICATIONS

This patent application relates to U.S. Provisional Application No. 61/263,250 filed Nov. 20, 2009 from which priority is claimed under 35 USC §119(e), and which provisional application is incorporated herein in its entirety.

This patent application is related to the following patent application which is owned by the assignee of this patent application: application Ser. No. 11/801,330 filed May 9, 2007.

### TECHNICAL FIELD OF THE INVENTION

One or more embodiments of the present invention relate to method and apparatus for displaying multiple Advertisers' offers within a single banner Ad Unit, and for collecting consumers' responses and self-reported personal information within that Ad Unit.

### BACKGROUND

The Internet has become an important medium for advertising. As is well known, one of the most common types of online advertising units is a banner Ad Unit. In general, banner Ad Units enable Advertisers to promote their product or service offerings to consumers by publishing their ads on websites within a discrete parcel of website “real estate” (standard sizes have been defined by the Internet Advertising Bureau (IAB)). Consumers interact with a banner Ad Unit typically by clicking on it, and then being redirected to the Advertiser's website.

In the past, each banner Ad Unit was purchased by a single Advertiser, and each banner Ad Unit only offered the single Advertiser's product or service. In the prior art, providing multiple Advertisers' product or service offerings in one banner Ad Unit was only possible via custom-built forms or via co-registration Ad Units that could only be placed in the registration process of a website. Both of these prior art solutions require iterative custom implementation by website Publishers, and they have only limited potential media reach due to the relatively small size of inventory available from registration paths versus the much larger addressable market of online banner advertising.

### SUMMARY

In accordance with one or more embodiments of the present invention, a display, multi-offer, banner Ad Unit is provided, and in particular, in accordance with one or more such embodiments, a multi-offer, banner Ad Unit is provided that fits within standard sizes for banner Ad Units that are set, for example, by the Internet Advertising Bureau (IAB). In accordance with one or more such embodiments, multi-offer, banner Ad Units can be automatically served via Internet ad servers to thousands, or even millions, of Publisher websites in a matter of seconds. This automation allows for cheap, fast distribution to many Internet users at low cost via a standard method of Internet ad distribution.

In accordance with one or more embodiments of the present invention, a new type of Internet banner Ad Unit is provided that can collect consumer lead data (for example and without limitation, self-reported, personal information data) for multiple Advertisers within a single banner Ad Unit. In accordance with one or more such embodiments, a consumer is enabled to: (a) select one, or more than one, Advertiser's offer, by selecting checkboxes within the banner Ad Unit, and then, (b) fill in data form fields that appear within the Ad Unit. Then, the consumer may submit the data by clicking a submit button, and the data is automatically sent to the Advertiser(s) via, for example and without limitation, a data transfer system such as the Pontiflex™ data transfer available from Pontiflex, Inc. of Brooklyn, N.Y. In particular, and for example, two embodiments of the present invention provide a Tower Ad Unit and a Square Ad Unit, respectively. Tower Ad Units are designed to accommodate vertically oriented rectangular ad sizes, and Square Ad Units are designed to accommodate proportional or roughly proportional Ad Units. These two size types correspond to most of the available banners sizes set by the IAB (www.iab.net/1325).

### BRIEF DESCRIPTION OF THE DRAWINGS

FIG. 1 is a block diagram of a system architecture of a computer system that provides a data bridge for transferring data between Publishers and Advertisers.

FIGS. 2-4 show screens used to describe a data consumer configurator of the computer system shown in FIG. 1.

FIGS. 5-7 show screens used to describe a data source configurator of the computer system shown in FIG. 1.

FIGS. 8-11 show screens used to describe a data transfer configurator of the computer system shown in FIG. 1.

FIGS. 12-14 show diagrams used to describe data components that make up a Data Source Configuration, a Data Consumer Configuration and a Data Transfer Configuration, respectively, as stored in a configuration data store of the computer system shown in FIG. 1.

FIG. 15 shows an HTML source code view of a sample data source-owned HTML web page that includes a BrowserScriptPost code snippet useful for sending data to the computer system shown in FIG. 1.

FIG. 16 shows pseudo code describing a JavaScript function of a component of the BrowserScriptPost code snippet shown in FIG. 15.

FIGS. 17A-17B show block diagrams used to describe a consumer's interaction with a Tower Ad Unit that is fabricated in accordance with one or more embodiments of the present invention.

FIGS. 18A-18B show block diagrams used to describe a consumer's interaction with a Square Ad Unit that is fabricated in accordance with one or more embodiments of the present invention.

FIG. 19 is a flow diagram showing a sequence of events from a consumer's perspective as the consumer interacts with an Ad Unit in accordance with one or more embodiments of the present invention.

FIG. 20 is a block diagram of components of an Ad Serving system that is fabricated in accordance with one or more embodiments of the present invention.

FIG. 21 shows an Offer object that has been fabricated in accordance with one or more embodiments of the present invention and its relationship to a Data Transfer Configuration.

FIG. 22 shows an Offer Configuration web form that is fabricated in accordance with one or more embodiments of the present invention for use by an Advertiser in creating the Offer object shown in FIG. 21.

FIGS. 23A-23B show block diagrams used to describe how to create a visual layout of a Tower Ad Unit, along with various components that are part of the Tower Ad Unit, in accordance with one or more embodiments of the present invention.

FIGS. 24A-24B show block diagrams used to describe how to create a visual layout of a Square Ad Unit, along with various components that are part of the Square Ad Unit, in accordance with one or more embodiments of the present invention.

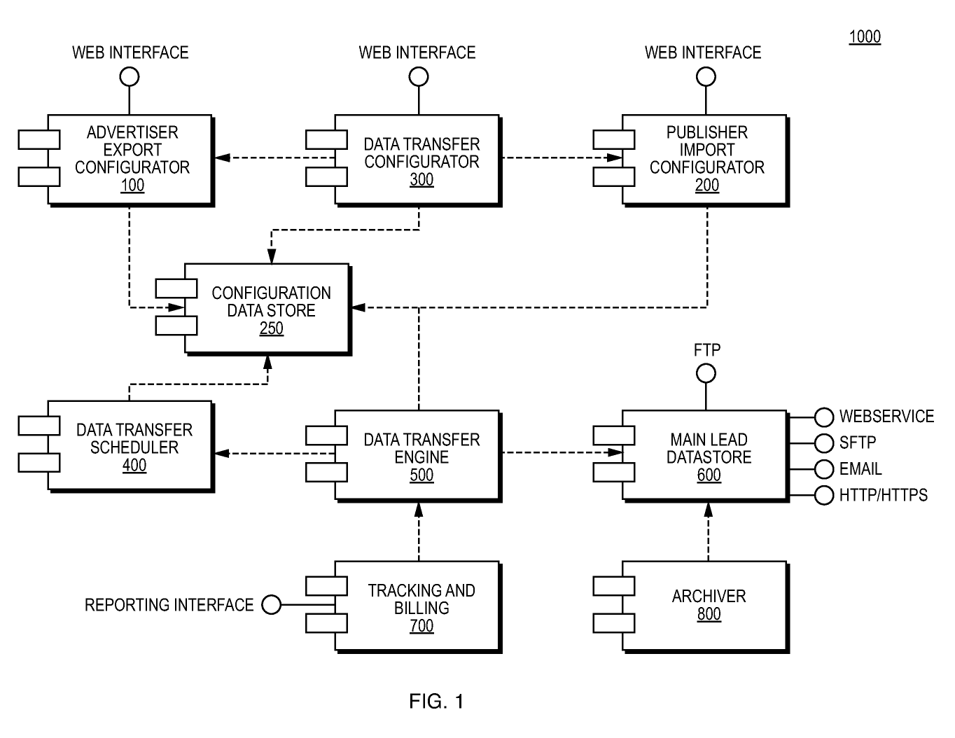

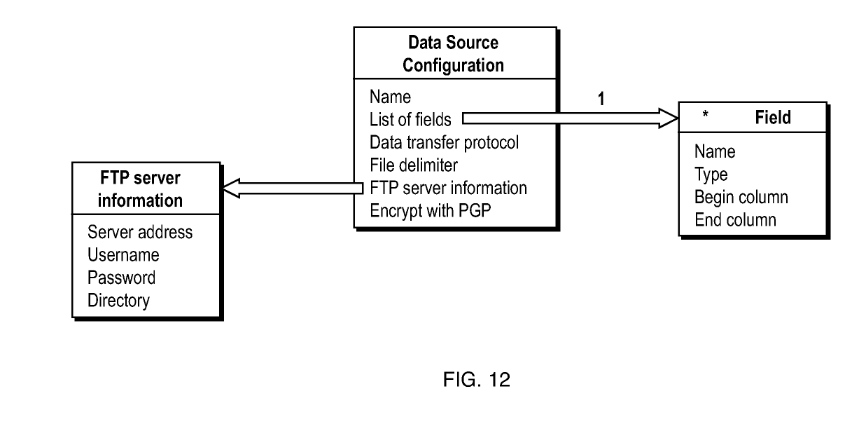

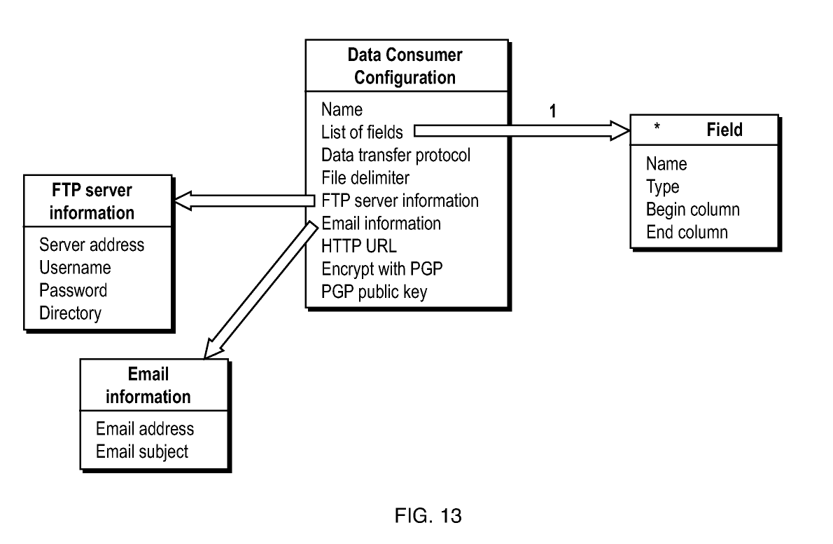

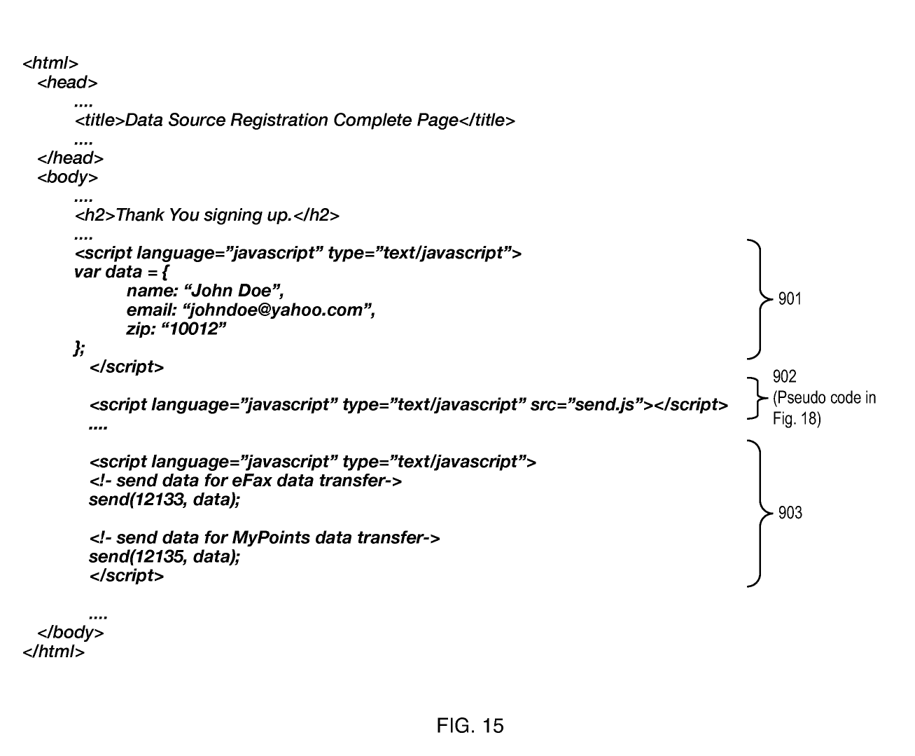

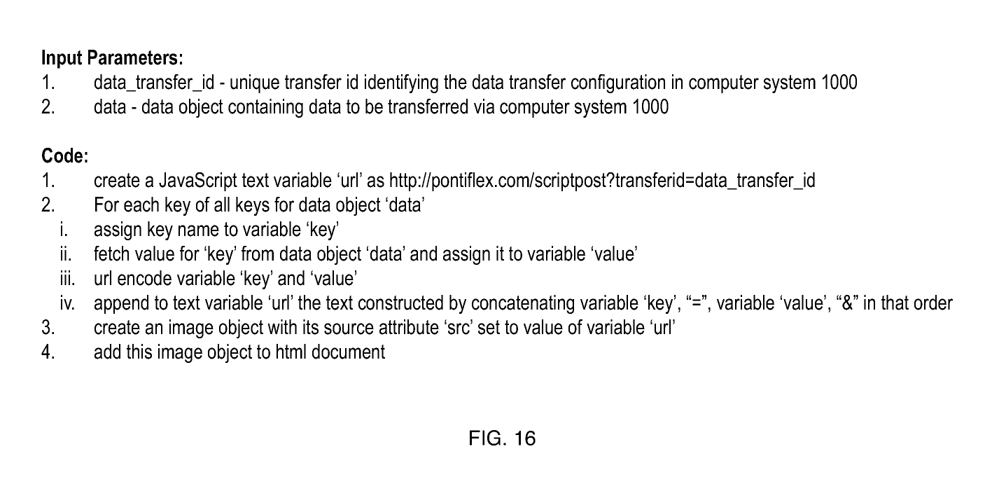

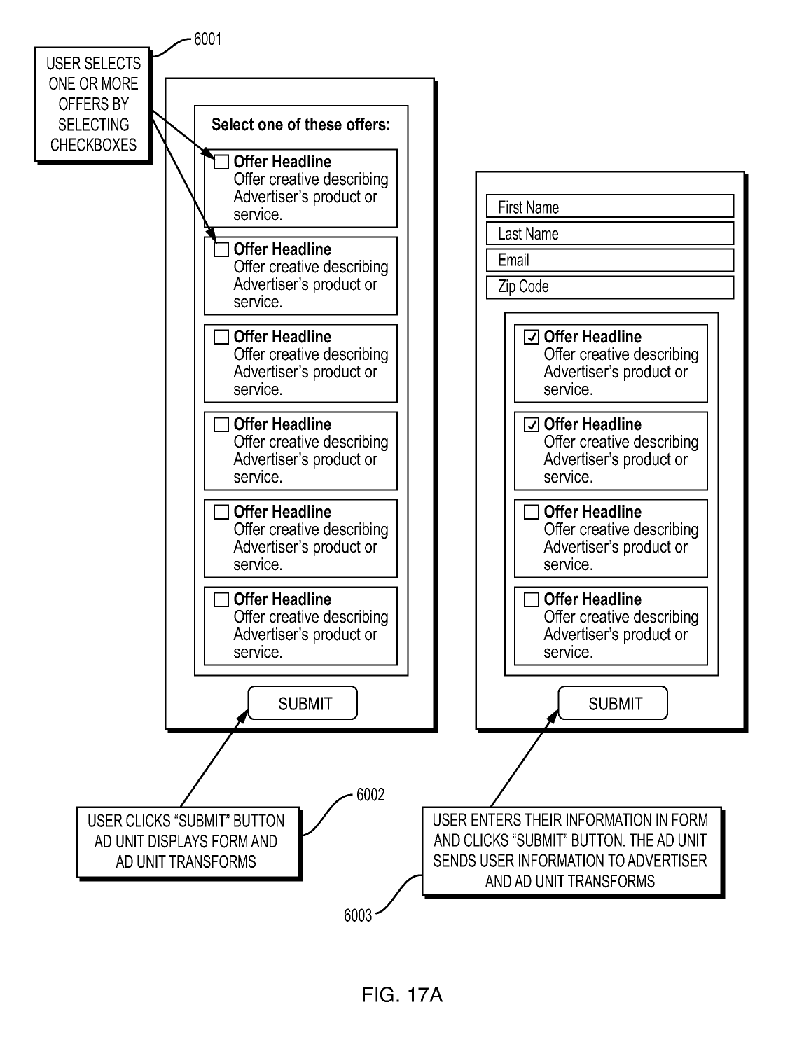

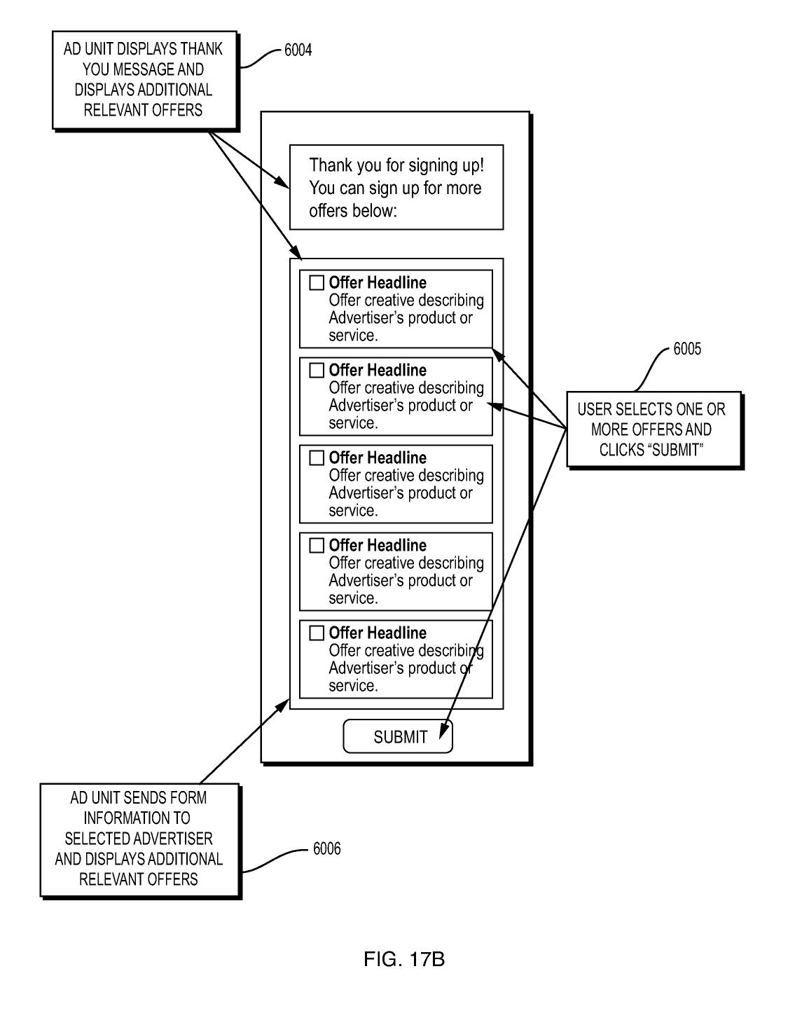

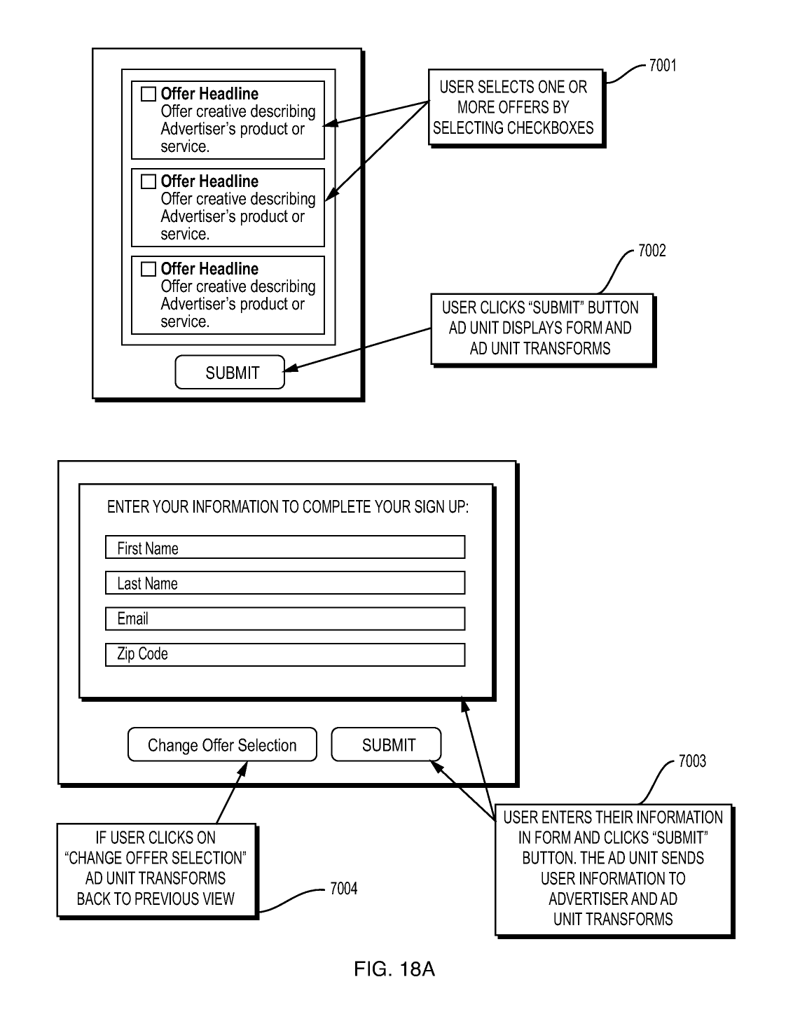

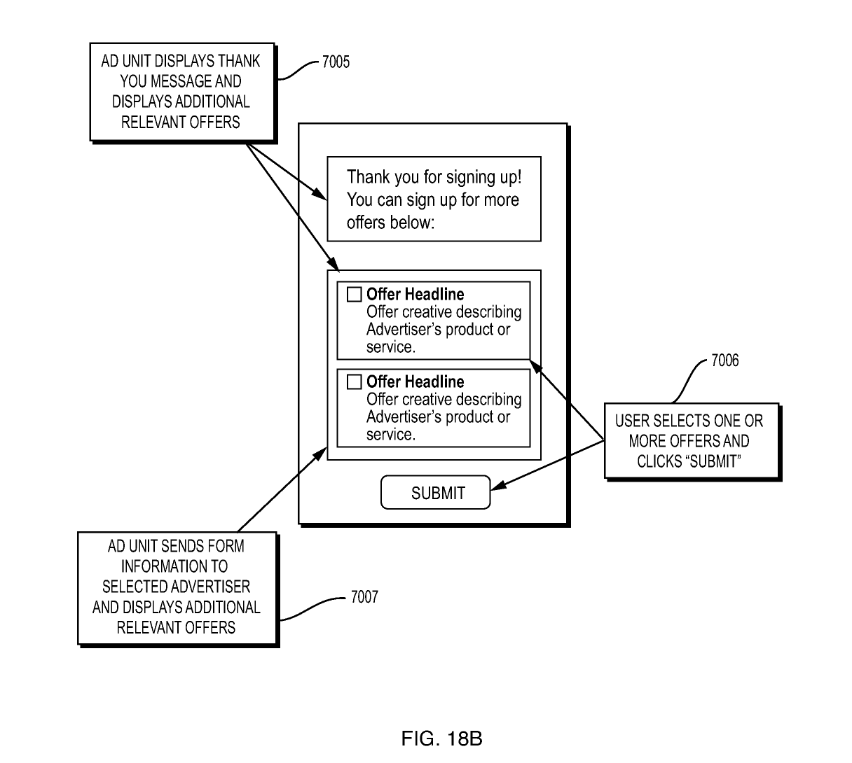

FIGS. 1-11 referenced above all come from, and have the same figure numbers assigned to them in, a U.S. patent application entitled “System and Method for Connecting and Managing Data Transfers Over the Internet,” having application Ser. No. 11/801,330, which application was filed on May 9, 2007, was published as U.S. Publication No. 2007/0294133A1 (referred to herein as the “Pontiflex Application”), and is assigned to the assignee of the present patent application, and which patent application and publication are incorporated by reference herein. FIGS. 12-14, 15 and 16 referenced above all come from the Pontiflex Application. In particular, FIGS. 12-14 of this application correspond to FIGS. 13-15 of the Pontiflex Application; FIG. 15 of this application corresponds to FIG. 17 of the Pontiflex Application; and FIG. 16 of this application corresponds to FIG. 18 of the Pontiflex Application.

### DETAILED DESCRIPTION

The Internet has become an important medium for advertising. In general, buyers and sellers of Internet advertising can be divided into two of the following categories: (a) Publishers (a Publisher is also referred to herein as a “data source”)—for example and without limitation, a Publisher is a website or a network of websites or a mobile phone network or a television network and so forth that displays advertising units on behalf of Advertisers (examples of Publishers are Aptimus, Valueclick, Verizon Wireless, Comcast Cable, New York Times Online, and Lycos); and (b) Advertisers (an Advertiser is also referred to herein as a “data consumer”)—for example and without limitation, an Advertiser is a company (selling one or more products and/or services) that contracts with a Publisher to display the Advertiser's ads or advertising units on or at the Publisher's site(s) (examples of Advertisers are HPShopping, Verisign, Circuit City and eFax).

As is well known, common types of online advertising units (Ad Units) are, for example and without limitation, banners, buttons, opt-ins, email and paid search. In general, Publishers display Ad Units for Advertisers. In addition, and in general, prior art online Ad Units can be divided into two of the following categories, which categories are based on a method by which Advertisers collect data from a consumer of an Advertiser's product(s) or service(s): (a) redirected Ad Units wherein a consumer clicks on a banner Ad Unit, search result, or other Ad Unit and is redirected (for example and without limitation, either in a new browser window or by refreshing a current browser window) to an Advertiser's web form—the consumer then manually completes the web form by entering required data; and (b) Publisher-collected Ad Units wherein the consumer takes some action (for example and without limitation, checking or leaving checked, a pre-selected check-box—often during a website registration process) that causes the Publisher to transfer the consumer's data in the background to the Advertiser.

In accordance with one or more embodiments of the present invention, a display, multi-offer, banner Ad Unit is provided, for example, and without limitation, a multi-offer, banner Ad Unit that fits within standard sizes for banner Ad Units set by the Internet Advertising Bureau (IAB). In accordance with one or more such embodiments of the present invention, a new type of Internet banner Ad Unit is provided that can collect consumer lead data (for example and without limitation, self-reported, personal information data) for multiple Advertisers within a single banner Ad Unit. In accordance with one or more such embodiments, a consumer is enabled to: (a) select one, or more than one, Advertiser's offer, by selecting checkboxes within the banner Ad Unit, and then, (b) fill in data form fields that appear within the Ad Unit. Then, the consumer may submit the data by clicking a submit button, and the data is automatically sent to the Advertiser(s), for example, and without limitation via a data transfer system such as the Pontiflex™ data transfer system available from Pontiflex, Inc. of Brooklyn, N.Y. In particular, and for example, two embodiments of the present invention provide a Tower Ad Unit and a Square Ad Unit, respectively. Tower Ad Units are designed to accommodate vertically oriented rectangular ad sizes, and Square Ad Units are designed to accommodate proportional, or roughly proportional, Ad Units. These two size types correspond to most of the available banners sizes set by the IAB (www.iab.net/1325).

One or more embodiments of the present invention are useful to three major stakeholders in an Internet advertising ecosystem; namely, Advertisers, Publishers and Consumers. Advertisers benefit by being able to collect an interested customer's contact information (so-called “lead data”) instead of just a click to a website which might never convert into an action or sign-up—beneficially, lead data can be reused and remarketed, whereas a click from a consumer disappears once a consumer leaves the Advertiser's website. Publishers benefit by receiving a higher payout for their advertising real estate—most Internet Publishers rely on advertising to fund their operations, and a drop in yields from advertising revenue can adversely affected many Publishers. In accordance with one or more embodiments of the present invention, because a consumer can select multiple Advertisers' offers within the same banner, the Publisher can be paid by multiple Advertisers rather than just one—thereby multiplying the yield of an Ad Unit. When a consumer selects more than one offer this can multiply the payout the Publisher obtains from that Ad Unit (based, for example, on how many offers the consumer selects). Internet users or consumers benefit for several reasons. They can opt-in to multiple Advertisers' offers instead of having to find and opt-in on a one-at-a-time basis—thereby gaining convenience and efficiency. They are not redirected away from their primary Internet surfing experience because they are opting-in to receive the information from the Advertiser(s) in their email inbox or via postal mail, and they are not being driven directly to an Advertiser's website.

One or more embodiments of the present invention use a Pontiflex™ data transfer system (described for example, in a U.S. patent application entitled “System and Method for Connecting and Managing Data Transfers Over the Internet,” having application Ser. No. 11/801,330, which application was filed May 9, 2007, was published as U.S. Publication No. 2007/0294133A1, and is assigned to the assignee of the present patent application, which patent application and publication are incorporated by reference herein, and which patent application is referred to herein as the “Pontiflex Application”) to manage routing and delivery of data from Ad Units to various Advertisers. Relevant aspects of the Pontiflex™ data transfer system are described herein in the Appendix. Beneficially, by using the Pontiflex™ data transfer system, data is delivered directly from Ad Units to Advertiser(s) with no additional work required by website Publishers. Advantageously, this improves the speed of data delivery, security, and convenience.

As described in the Appendix, and as shown in FIG. 1 (this is also FIG. 1 of the Pontiflex Application), the Pontiflex™ data transfer system is a computer system (computer system 1000) that provides a data bridge connecting Publishers (a Publisher is also referred to herein as a data source“), for example and without limitation, online Publishers, to Advertisers (an Advertiser is also referred to herein as a data consumer”), for example and without limitation, online Advertisers, to transfer data between them. In particular, the Pontiflex™ data transfer system mediates data transfers so that data sources can connect to computer system 1000 (shown in FIG. 1) in their preferred data transfer protocols to send data, and data consumers can build connections to computer system 1000 in their preferred data transfer protocols to receive data. By converting data received from data sources into data sent to data consumers, computer system 1000 provides a flexible “data bridge” that enables simple connectivity between parties, immediate delivery of customer data, and lowered cost of doing business.

As further described in the Appendix, computer system 1000 integrates online data transfers (typically comprised of data provided by consumers such as, for example and without limitation, name, email address, zip code, credit card number, or other information) between Publishers and Advertisers using a set up process. Once the set up process is complete, computer system 1000 translates data received from a Publisher (i.e., a data source) and sends the data to an Advertiser (i.e., a data consumer) by automatically recognizing a data output format provided by the Publisher and converting that information into a data input format required by the Advertiser.

As further described in the Appendix, a data source has an option to send data to computer system 1000 using a BrowserScriptPost code snippet that is generated by computer system 1000, and is available to be downloaded by the data source via a computer-system-provided web interface (alternatively, computer system 1000 may provide the BrowserScriptPost code snippet by email or a user of computer system 1000 may cause the BrowserScriptPost code snippet to be downloaded manually).

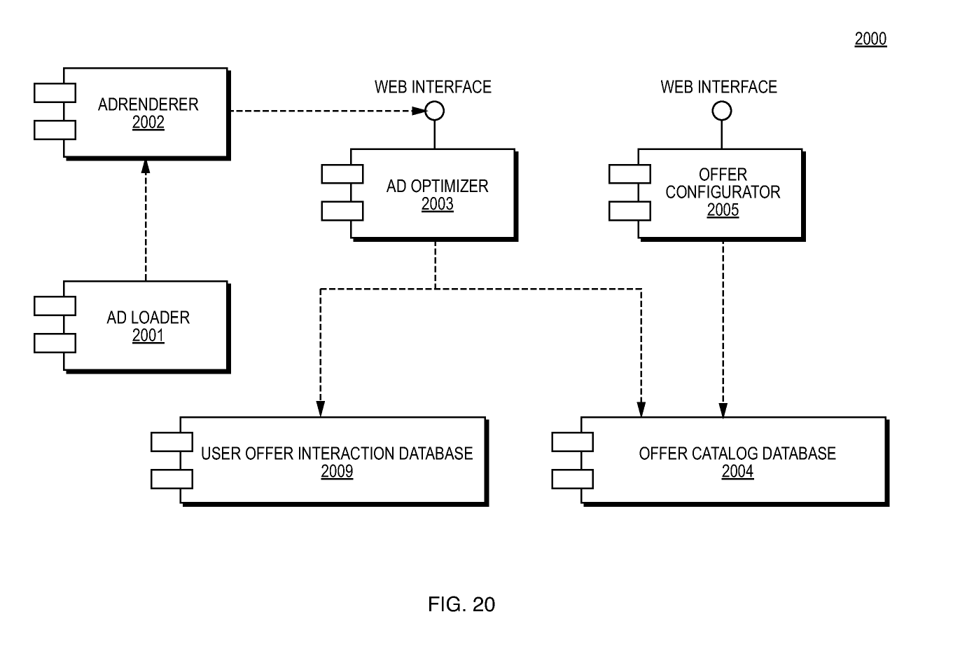

In accordance with one or more embodiments of the present invention, an Ad Serving system (also referred to herein as a Pontiflex™ Ad Serving system) is a system that displays advertisements from Advertisers in the form of various Ad Units on a Publishers website. In accordance with one or more such embodiments of the present invention, an Ad Unit displayed by one or more embodiments of a Pontiflex™ Ad Serving system displays advertisements from one or more Advertisers at the same time, and enables a consumer to enter his/her personal information (for example and without limitation, name, email address and telephone number) and select one or more of the advertisements. In accordance with one or more such embodiments of the present invention, consumer interaction with the Ad Unit triggers code, for example and without limitation, BrowserScriptPost code (described below in the Appendix), to send consumer data to Advertiser(s), for example and without limitation, via the Pontiflex™ data transfer system of computer system 1000 which is described below in the Appendix. FIG. 20 is a block diagram of Ad Serving system 2000 that is fabricated in accordance with one or more embodiments of the present invention. As shown in FIG. 20, in accordance with one or more embodiments of the present invention, Pontiflex™ Ad Serving system 2000 comprises: (a) Ad Loader 2001 and Ad Renderer 2002 (which are associated with, or run from, a Publisher's Ad Server); and (b) Ad Optimizer 2003, Offer Catalog Database 2004, Offer Configurator 2005 and User Offer Interaction Database 2009 (which are modules of an Ad Serving computer system, for example and without limitation, a centralized computer system that may be accessed/used by a number of Publishers and Advertisers). As one of ordinary skill in the art can readily appreciate, Ad Loader 2001, Ad Renderer 2002, Ad Optimizer 2003, Offer Catalog Database 2004, Offer Configurator 2005 and User Offer Interaction Database 2009 are combinations of software modules and computer hardware that provide functionality that will be described in detail below.

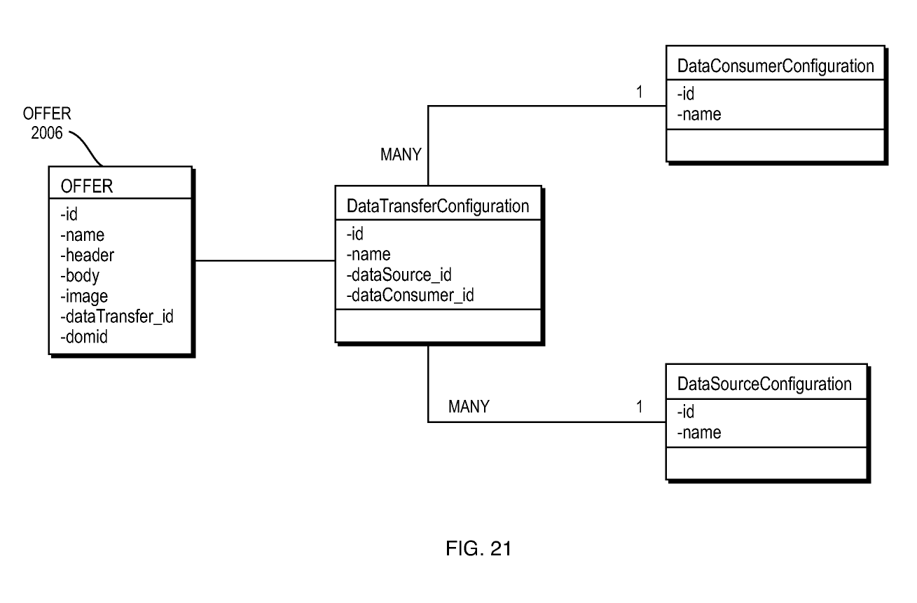

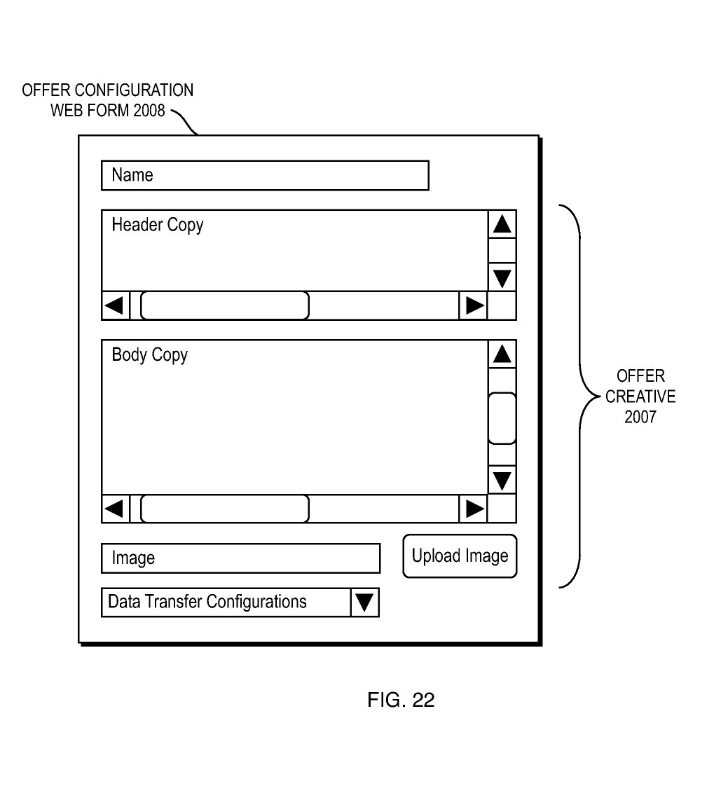

In accordance with one or more embodiments of the present invention, Offer Configurator 2005 shown in FIG. 20 is a module of Ad Serving system 2000, and Offer Configurator 2005 provides a web interface that is used by an Advertiser to create an Offer object. In accordance with one or more such embodiments, the web interface provides Offer Configuration web form 2008 shown in FIG. 22. As used herein, an Offer object is a singular instance of an advertisement (that is created by an Advertiser) to be run on a Publisher's website. FIG. 21 shows Offer object 2006 that has been fabricated in accordance with one or more embodiments of the present invention and its relationship to a Data Transfer Configuration that is created by an Advertiser using the Pontiflex™ data transfer system (as described in the Appendix in conjunction with the Pontiflex Application).

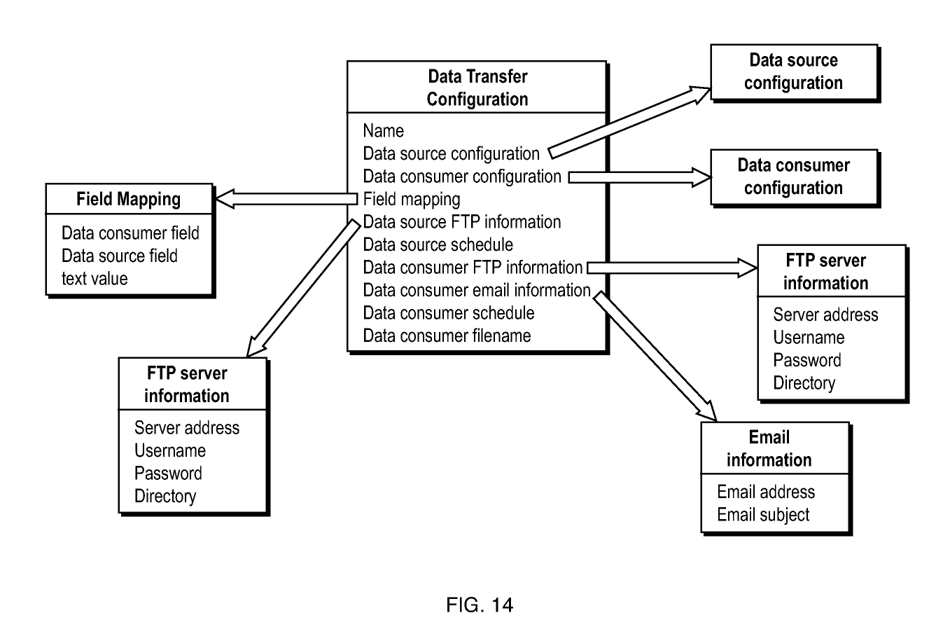

FIG. 22 shows Offer Configuration web form 2008 that is fabricated in accordance with one or more embodiments of the present invention. In accordance with one or more embodiments of the present invention, as shown in FIG. 21, Offer object 2006 typically includes various pieces of text that are collectively referred to as an “Offer Creative.” In accordance with one or more such embodiments, an Offer Creative may also include one or more HTML Image(s). Offer Creative Portion 2007 of Offer Configuration web form 2008 comprises a portion of Offer Configuration web form 2008 used for entering the components of an Offer Creative. In accordance with one or more such embodiments of the present invention, Offer object 2006 also includes an id for a Data Transfer Configuration “dataTransfer_id” (described in the Appendix in conjunction with FIG. 14, this is FIG. 15 of the Pontiflex Application) that was created previously by the Advertiser using the Pontiflex™ data transfer system of computer system 1000. The Data Transfer Configuration links: (a) an Advertiser's Data Consumer Configuration (described in the Appendix in conjunction with FIG. 13, this is FIG. 14 of the Pontiflex Application) with (b) a Publisher's Data Source Configuration (described in the Appendix in conjunction with FIG. 12, this is FIG. 13 of the Pontiflex Application). The Advertiser's Data Consumer Configuration is created by the Advertiser using a web interface of Advertiser Export Configurator 100 of the Pontiflex™ data transfer system of computer system 1000 (as described in the Appendix in conjunction with FIG. 1, this is also FIG. 1 of the Pontiflex Application). The Publisher's Data Source Configuration is created by the Publisher using a web interface of Publisher Import Configurator 200 of the Pontiflex™ data transfer system of computer system 1000 (as described in the Appendix in conjunction with FIG. 1, this is also FIG. 1 of the Pontiflex Application). The Data Transfer Configuration is created by the Advertiser using a web interface of Data Transfer Configurator 300 of the Pontiflex™ data transfer system of computer system 1000 (as described in the Appendix in conjunction with FIG. 1, this is also FIG. 1 of the Pontiflex Application). As further described in the Appendix, the Data Source Configuration, the Data Consumer Configuration and the Data Transfer Configuration are stored in a configuration data store 250 of computer system 1000 (as described in the Appendix in conjunction with FIG. 1, this is also FIG. 1 of the Pontiflex Application).

In accordance with one or more embodiments of the present invention, to create an Offer object using Offer Configuration web form 2008, an Advertiser: (a) enters a name for the Offer which is used by the Advertiser to identify the Advertising Offer (i.e., it is a human readable identifier of the Advertising Offer in Offer Catalog Database 2004—the name does not to be unique in the database, it ought to be just different enough for the advertiser to visually identify it from other offers the Advertiser has created); (b) enters Offer Creative—this typically includes text for a header, text for a body and an optional image; and (c) selects one Data Transfer Configuration the Advertiser has created, for example, and without limitation, using a drop down menu. Then, Offer Configurator 2005 creates a numeric id (“id”) which may also serve as an identifier of Offer object 2006 in Offer Catalog Database 2004. Then, the Advertiser clicks on a Save button, at which instance, Offer Configurator 2005 creates and saves the new Offer object in Offer Catalog Database 2004 shown in FIG. 20.

In accordance with one or more embodiments of the present invention, Ad Optimizer 2003 shown in FIG. 20 is a module of Ad Serving system 2000, and Ad Optimizer 2003 provides a web interface that, upon request, returns a list of Offers from Offer Catalog Database 2004 that a consumer is likely to select (in light of the information and techniques used to provide the list) when presented to him/her in an Ad Unit. In accordance with one or more such embodiments, the list of Offers is returned in a format that can be read by Ad Renderer 2002, and in accordance with one or more such embodiments, the list is returned as a JSON formatted string, where JSON (JavaScript Object Notation) is a lightweight data-interchange format. JSON is based on a subset of the JavaScript Programming Language, Standard ECMA-262 3rd Edition—December 1999. JSON is a text format that is language independent but uses conventions that are familiar to programmers of the C-family of languages, including C, C++, C#, Java, JavaScript, Perl, Python, and many others.

In accordance with one or more embodiments of the present invention, inputs (which inputs are provided as described in detail below) to a web interface provided by Ad Optimizer 2003 are: (a) an id of a Data Source Configuration; (b) a list of zero or more keywords (for example and without limitation, a list of plain text words separated by commas) which describe the Publisher website's content and which keywords allow the selection of relevant offers which are contextual to the web site's content, and which offers therefore, are believed to yield a higher response rate for an advertisement; (c) an optional, non-personally identifying cookie from the consumer's browser; (d) zero or more ids of Offers which represent Offers a consumer had selected; and (e) an integer representing a number of Offers Ad Optimizer 2003 should return (i.e., a number of requested Offers). Then, in response, Ad Optimizer 2003 uses the id of the Data Source Configuration to determine an initial list of Offers that are present in Offer Catalog Database 2004 which use a Data Transfer Configuration that uses the Data Source Configuration by querying Offer Catalog Database 2004 using a database query language such as, for example and without limitation, SQL. In accordance with one or more embodiments of the present invention, Ad Optimizer 2003 returns a list of the retrieved Offers (restricting the list to include no more than the number of requested Offers). In accordance with one or more alternative embodiments, Ad Optimizer 2003 filters the list of Offers down to a list of Offers that are more likely to be selected by consumers in an Ad Unit using commonly available techniques such as, for example and without limitation, Contextual Targeting, Behavioral Targeting or Collaborative Filtering. In accordance with one or more such alternative embodiments of the present invention, Ad Optimizer 2003 uses the list of keywords and applies Contextual Targeting techniques that are well known to those of ordinary skill in the art to determine which Offers are more likely to be selected by a consumer in the context of the Publisher website's content. In accordance with one or more further such alternative embodiments of the present invention, Ad Optimizer 2003 uses the optional, non-personally identifying cookie and applies Behavioral Targeting techniques that are well known to those of ordinary skill in the art to determine automatically which Offers are more likely to be selected by a consumer based on his/her previous interactions (i.e., selected previously) with other Offers in accordance with any one of a number of commonly available embodiments of Behavioral Targeting techniques. In accordance with one or more still further such alternative embodiments of the present invention, Ad Optimizer 2003 applies Collaborative Filtering techniques that are well known to those of ordinary skill in the art to determine automatically which Offers are more likely to be selected in the context of Offers which have been selected already by the consumer in accordance with any number of commonly available embodiments of collaborative filtering techniques. In accordance with one or more embodiments of the present invention, data relating to Offers previously selected by a consumer were transmitted by Ad Renderer 2002 to Ad Optimizer 2003, and Ad Optimizer 2003 stored the data in User Offer Interaction Database 2009 of Ad Serving system 200, refer to FIG. 20.

Ad Loader 2001

In accordance with one or more embodiments of the present invention, Ad Loader 2001 shown in FIG. 20 is a software module that runs inside a Publisher's web browser, and in accordance with one or more such embodiments, Ad Loader 2001 is provided, for example and without limitation, in JavaScript code. In accordance with one or more such embodiments of the present invention, a Publisher includes Ad Loader 2001 in its web page by inserting two HTML Script tags into the HTML of its web page. Alternatively, the Publisher may insert Ad Loader 2001 into an Ad Server application the Publisher might use to display Ad Units on its web pages. Publishers typically use licensed 3^{rd} party Ad Servers like Doubleclick Ad Server or Right Media Ad Server to manage Ad Units running on their websites. In such a scenario, a Publisher can insert Ad Loader 2001 into its existing 3^{rd} party Ad Server, thereby making the Ad Units provided by embodiments of the present invention compatible with these 3^{rd} party Ad Servers. In accordance with one or more such embodiments, the first HTML Script tag includes a JavaScript associative array called adOptions that specifies information used by functions defined in JavaScript code of Ad Renderer 2002 to create the Ad Unit.

In accordance with one or more such embodiments, the associative array adOptions contains values for the following keys: (a) type, where the value of type is the type of Ad Unit (for example and without limitation, “Tower” or “Square”); (b) width, where the value of width is the width of the Ad Unit (for example, in pixels); (c) height, where the value of height is the height of the Ad Unit (for example, in pixels); (d) initNumOffers, where the value of initNumOffers is an initial number of offers to display inside the Ad Unit; (e) formNumOffers, where the value of formNumOffers is a number of offers to display along with a web form inside an Ad Unit; (f) afterformNumOffers, where the value of afterFormNumOffers is a number of offers displayed after the initial submission of a web form inside the Ad Unit; and (g) dataSourceId, where the value of dataSourceId is the id of the Data Source Configuration for the Publisher.

The second HTML Script tag has its “src” attribute set, for example and without limitation, to a company-hosted, for example and without limitation, a Pontiflex™, Inc.-hosted, URL which points to an HTML page that contains the JavaScript code of Ad Loader 2001. Thus, in accordance with one or more embodiments of the present invention, the URL pointing to Ad Loader 2001 may be a system defined, known, constant url location. In accordance with one or more embodiments of the present invention, a Publisher obtains the two Ad Loader 2001 HTML Script tags using a web interface provided by Offer Configurator 2005.

Ad Renderer 2002

In accordance with one or more embodiments of the present invention, Ad Renderer 2002 shown in FIG. 20 is a software module that runs inside a Publisher's web browser, and in accordance with one or more such embodiments, Ad Renderer 2002 is provided, for example and without limitation, in JavaScript code. In accordance with one or more such embodiments of the present invention, an HTML Ad Unit is created by Ad Renderer 2002 running inside the Publisher's web browser.

In accordance with one or more such embodiments of the present invention, Ad Renderer 2002 is loaded by Ad Loader 2001 via an HTML Iframe tag stored, for example and without limitation, on Ad Serving system 2000 with its “src” attribute set, for example and without limitation, to a company-hosted, for example and without limitation, a Pontiflex™, Inc.-hosted, URL which points to an HTML page which contains the JavaScript code of Ad Renderer 2002 for the Publisher's web page. Thus, in accordance with one or more embodiments of the present invention, the URL pointing to Ad Renderer 2002 may be a system defined, known, constant url location (for example and without limitation, it is hard coded inside AdLoader 2001).

The sections below describe how Ad Loader 2001 loads Ad Renderer 2002 for each type of Ad Unit (specified by the value of the type key in the associative array adOptions). In accordance with one or more embodiments of the present invention, Ad Renderer 2002 is a collection of JavaScript functions: drawAd( ), initialSelectOffer( ), backToOfferSelection( ), submitForm( ), validateForm( ), and resubmitForm( ).

In accordance with one or more embodiments of the present invention, Ad Renderer 2002 defines a function called Offer( ) which is used as a class constructor for describing an Advertiser Offer to be placed on the HTML Ad Unit. This Offer class has the following fields (refer to FIG. 21): (a) data transfer id (i.e., dataTransfer_id, a number used to identify, for example and without limitation, a unique Pontiflex™ Data Transfer Configuration used to send data collected from this Ad Unit to Advertiser(s)); (b) dom id (an alphanumeric); (c) Offer id (a numeric id identifying the Advertising Offer in Offer Catalog Database 2004); and (d) Offer Creative (an associative array consisting of texts for “header,” “body,” and an optional url for “imageUrl”).

Ad Renderer 2002 defines an associative array called offers which associates a numeric Offer id with a JavaScript object of type Offer. Ad Renderer 2002 also defines an array called selectedOfferIDs which Ad Renderer 2002 uses to store the numeric Offer id of Offers selected by a consumer during his/her interaction with the Ad Unit.

Tower Ad Unit

If the value of the type key in the associative array adOptions placed on the Publisher's website or the Publisher's Ad Server is set to “Tower,” the Ad Unit is rendered as a Tower Ad Unit. By the nature of how an HTML Script tag works, the web browser will execute the JavaScript code inside Ad Loader 2001. In accordance with one or more embodiments of the present invention, Ad Loader 2001 checks the value of the type key in the associative array adOptions. If the value of the type key is set to “Tower,” Ad Loader 2001 creates an HTML Iframe “Frame A” with a width and height specified in the associative array adOptions. Then, Ad Loader 2001 sets the “src” attribute of HTML Iframe “Frame A” to, for example and without limitation, to a company-hosted, for example and without limitation, a Pontiflex™, Inc.-hosted, URL which points to an HTML page containing the JavaScript code for Ad Renderer 2002. The contents of the associative array adOptions are passed to this URL as HTTP GET parameters (where a parameter name is set to the key name in the associative array adOptions, and the value of the parameter is set to the value of the key in the associative array adOptions).

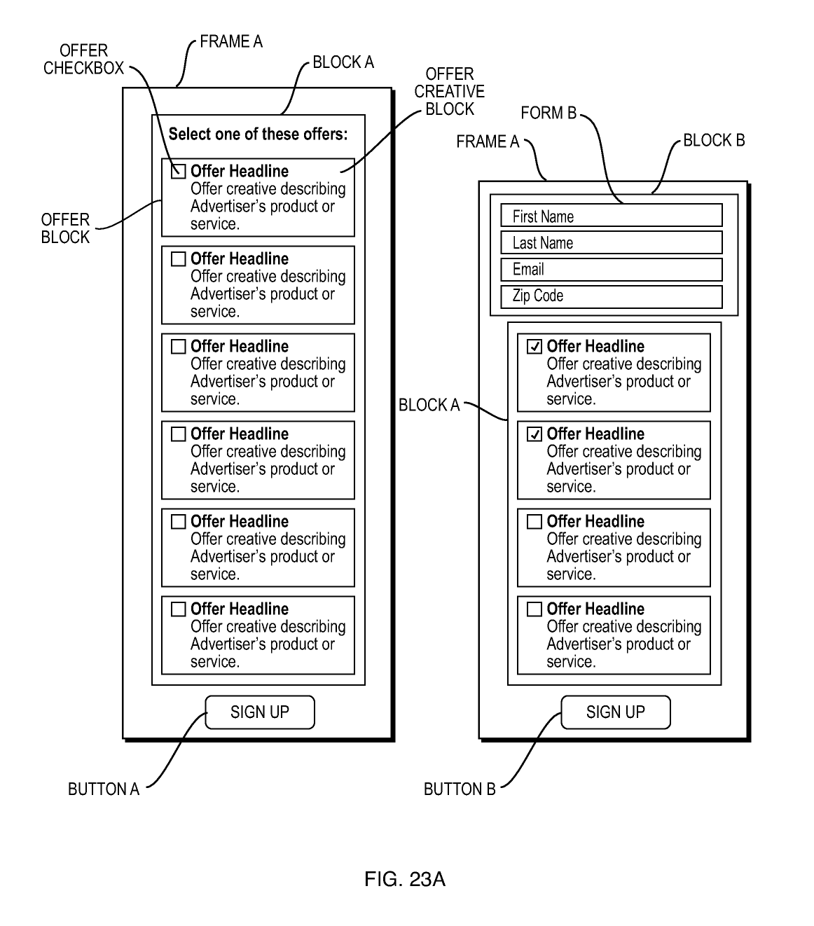

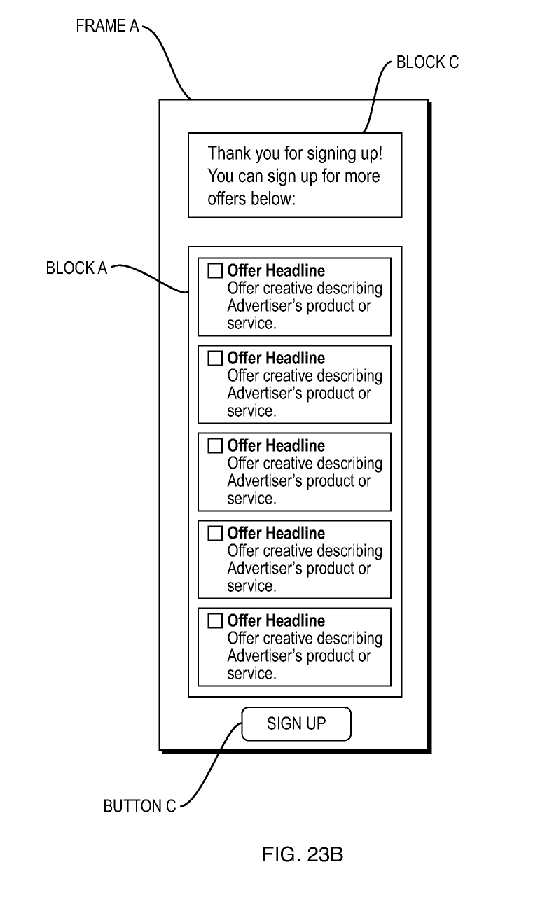

FIGS. 23A-23B show block diagrams used to describe how to create a visual layout of a Tower Ad Unit, along with various components that are part of the Tower Ad Unit, in accordance with one or more embodiments of the present invention. The sections below describe how these various components are created by Ad Renderer 2002, and how Ad Renderer 2002 responds to consumer interaction with the various components of the Tower Ad Unit.

Initializing the Ad Unit

In accordance with one or more embodiments of the present invention, execution of the JavaScript code inside Ad Renderer 2002 first invokes the function drawAd( ). The function drawAd( ) executes the following.

The function drawAd( ) of Ad Renderer 2002 reads the HTTP GET parameters, and recreates the associative array adOptions. For each HTTP GET parameter, the function drawAd( ) of Ad Renderer 2002 associates a key equal to the HTTP GET parameter name to a value equal to the HTTP GET parameter value. Next, the function drawAd( ) of Ad Renderer 2002 creates an HTML Div “BlockA” (refer to FIG. 23A) inside the Iframe “FrameA” (refer to FIG. 23A). Next, the function drawAd( ) of Ad Renderer 2002 calls Ad Optimizer 2003 (through its web interface) and passes: (a) the value of the key dataSourceID in the associative array adOptions as the id of the Data Source Configuration; (b) a list of keywords representing the Publisher's website content; and (c) the value of the key initNumOffers in the associative array adOptions as the number of offers to fetch. In response, the function drawAd( ) of Ad Renderer 2002 receives a list of Advertiser Offers in JSON format. Next, the function drawAd( ) of Ad Renderer 2002 writes the Advertiser Offers inside the HTML Div “BlockA” (refer to FIG. 23A). For each Advertiser Offer, the function drawAd( ) of Ad Renderer 2002 executes the following steps. The function drawAd( ) of Ad Renderer 2002 creates a new Offer object, and sets: (a) the value of “data transfer id” in the Offer object to the Pontiflex™ Data Transfer Id for the Advertiser Offer; and (b) the value of “dom id” in the Offer object to a value created by joining the text “offer_” with the numeric Offer id. Next, the function drawAd( ) of Ad Renderer 2002 creates a new entry in the associative array offers linking the Offer id to the Offer object. Next, the function drawAd( ) of Ad Renderer 2002: (a) creates an HTML Div “OfferBlock” (refer to FIG. 23A); (b) sets the “id” attribute of this HTML Div “OfferBlock” to the value of “dom id” of the Offer object created in the previous step; and (c) inside this HTML Div “OfferBlock,” creates an HTML checkbox “OfferCheckbox” (refer to FIG. 23A) and a corresponding HTML Div “OfferCreativeBlock” that contains the Offer Creative (refer to FIG. 23A). The Offer Creative typically consists of a piece of text referred to as Offer Copy and may also include an HTML Image. Next, the function drawAd( ) of Ad Renderer 2002 sets the “id” attribute of the HTML checkbox “OfferCheckbox” to a value created by joining the text “offer_checkbox_” with the numeric Offer id.

Next, below the HTML Div “BlockA,” the function drawAd( ) of Ad Renderer 2002 creates an HTML button “ButtonA” (refer to FIG. 23A) and attaches a call to function initialSelectOffer( ) to the “onclick” event handler of HTML button “ButtonA.” Next, the function drawAd( ) of Ad Renderer 2002 creates an HTML Div “BlockB” (refer to FIG. 23A), and creates an HTML form “FormB” (refer to FIG. 23A) inside HTML Div “BlockB.” Next, inside “FormB,” the function drawAd( ) of Ad Renderer 2002 creates HTML input text fields for common fields, for example and without limitation: first name, last name, email and zip code (refer to FIG. 23A). Next, the function drawAd( ) of Ad Renderer 2002 makes HTML Div “BlockB” invisible using the CSS (Cascading Style Sheet) “display” attribute of HTML Div “BlockB.” Next, as the value of the type key in the associative array adOptions is set to “Tower,” the function drawAd( ) of Ad Renderer 2002 creates an HTML button “ButtonB” (refer to FIG. 23A) having the same position as HTML button “ButtonA,” and attaches a call to function submitForm( ) to the “onclick” event handler of HTML button “ButtonB.” Next, as the value of the type key in the associative array adOptions is set to “Tower,” Ad Renderer 2002 makes HTML button “ButtonB” invisible using the CSS “display” attribute of HTML button “ButtonB.” Next, the function drawAd( ) of Ad Renderer 2002 creates an HTML Div “BlockC” (refer to FIG. 23B) which contains text that is to be displayed to the consumer at the end of the consumer's submitting consumer data in HTML form “FormB.” This text typically consists of a message thanking the consumer for submitting his/her information in HTML form “Form B” (refer to FIG. 23B). Next, the function drawAd( ) of Ad Renderer 2002 makes HTML Div “BlockC” invisible using the CSS “display” attribute of HTML Div “BlockC.” Next, the function drawAd( ) of Ad Renderer 2002 creates an HTML button “ButtonC” (refer to FIG. 23B) having the same position as HTML button “ButtonA,” and attaches a call to function resubmitForm( ) to the “onclick” event handler of HTML button “ButtonC.” Next, the function drawAd( ) of Ad Renderer 2002 makes HTML button “ButtonC” invisible using the CSS “display” attribute of HTML button “ButtonC.”

Capturing Consumer Interaction with Ad Unit

FIGS. 17A-17B show block diagrams used to describe a consumer's interaction with a Tower Ad Unit that is fabricated in accordance with one or more embodiments of the present invention. As shown in FIG. 17A, the consumer views the Ad Unit on a Publisher's web page, reviews the various Advertisers' Offers, and if interested, selects one or more of the offers by selecting the checkbox or checkboxes next to the Advertisers' Offers (refer to box 6001 of FIG. 17A). When the consumer has selected one or more offers, he/she clicks a submit button. Upon clicking the submit button, a data entry form is displayed in the banner Ad Unit (refer to box 6002 of FIG. 17A). The consumer completes the fields in the data entry form, and clicks a submit button to finish (refer to box 6003 of FIG. 17A). Upon clicking the submit button, the consumer is presented with an acknowledgement message thanking him/her for signing up (refer to box 6004 of FIG. 17B). At this point, additional offers may also be displayed in the banner Ad Unit. The consumer may select one or more of the additional offers by selecting the checkbox or checkboxes next to the Advertisers' Offers and clicking a submit button (refer to box 6005 of FIG. 17B). At this point, additional offers may be displayed in the banner Ad Unit (refer to box 6006 of FIG. 17B).

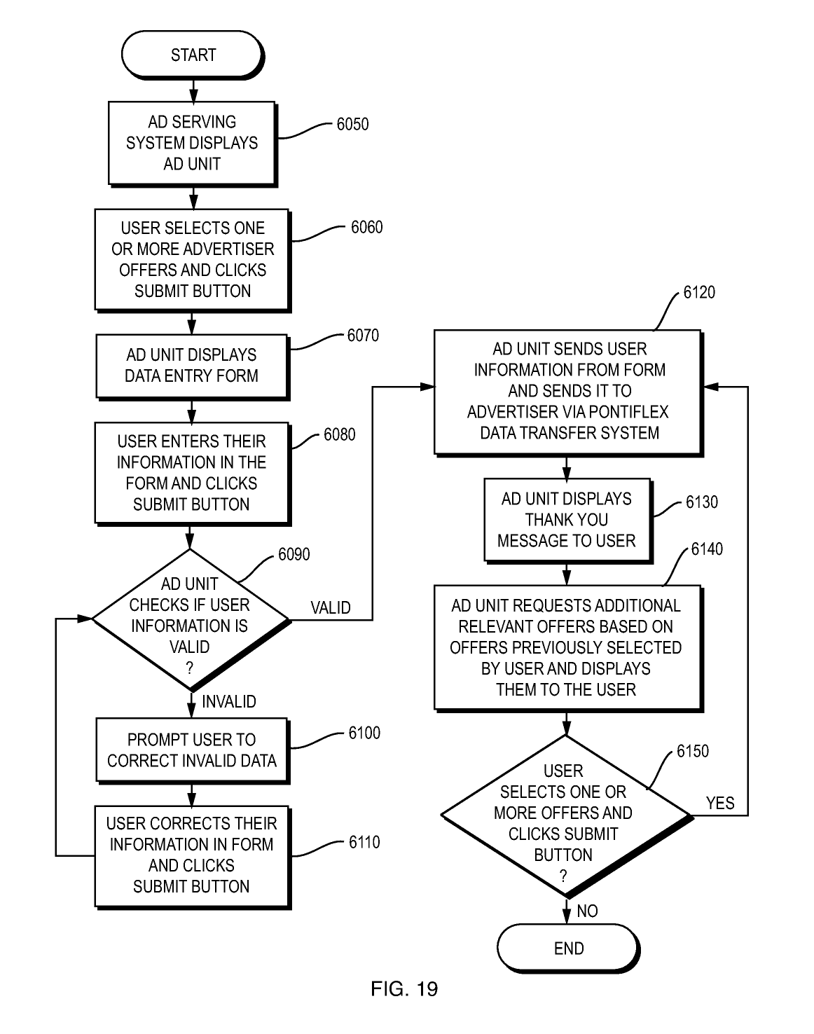

FIG. 19 is a flow diagram showing a sequence of events from a consumer's perspective as the consumer interacts with an Ad Unit in accordance with one or more embodiments of the present invention. As indicated at box 6050 of in FIG. 19, and as described above, Ad Serving system 2000 displays an Ad Unit on a Publisher's website. Next, as indicated at box 6060 of FIG. 19, the consumer selects one or more of the Advertisers' offers, and clicks the submit button. Next, as indicated at box 6070 of FIG. 19, in response, a data entry form is displayed which typically requests consumer information like first name, last name, email, and zip code. Next, as indicated at box 6080 of FIG. 19, the consumer enters his/her information in the data entry form, and clicks on the submit button. Next, as indicated at decision box 6090 of FIG. 19, in response, a check is made to determine whether the consumer information is valid. Examples of common checks are checking: (a) whether the consumer has entered information for all required fields; (b) whether the email address has the correct syntax; and so forth. If the consumer information is invalid, as indicated at box 6100 of FIG. 19, the consumer is prompted to correct the errors. Next, as indicated at box 6110 of FIG. 19, the consumer corrects his/her information, and clicks on the submit button again. If the consumer information is valid, as indicated at box 6120 of FIG. 19, the consumer information from the form is sent to each of the selected Advertisers using, for example and without limitation, the Pontiflex™ Data Transfer System. Next, as indicated at box 6130 of FIG. 19, a thank you message is displayed to the consumer. Next, as indicated at box 6140 of FIG. 19, a request is made to Ad Serving system 2000 to fetch additional Advertisers' Offers based on offers already selected by the consumer prior to receiving the thank you message. Then, the additional Offers are displayed to the consumer. The consumer can select one of these offers and click on the submit button. Next, as indicated at decision box 6150 of FIG. 19, a check is made to determine whether the user has selected one or more offers. If so, control is transferred back to box 6120 where the previously collected consumer information will be sent to the selected Advertisers using, for example and without limitation, the Pontiflex™ Data Transfer System and the cycle can continue for further consumer interaction with the Ad Unit. If not, the interaction ends.

Initial Selection of Offers by Consumer

After an Ad Unit has been initialized, a consumer interacts with the Ad Unit by selecting one or more checkboxes inside HTML Div “Block A” (refer to FIG. 23A), and clicking on HTML button “ButtonA” (refer to FIG. 23A). On clicking on HTML button “ButtonA,” the Publisher's web browser calls the registered “onclick” function initialSelectOffer( ) of Ad Renderer 2002 of HTML button “ButtonA.” The function initialSelectOffer( ) of Ad Renderer 2002 executes the following.

Function initialSelectOffer( ) of Ad Renderer 2002 fetches a list of all checkboxes inside HTML Div “BlockA,” and checks if at least one of the checkboxes has been selected. If none of the checkboxes has been selected, it calls JavaScript function alert with a message informing the consumer that he/she has to select at least one offer inside HTML Div “BlockA.” After that, the function initialSelectOffer( ) of Ad Renderer 2002 exits. If at least one of the checkboxes has been selected, the function initialSelectOffer( ) of Ad Renderer 2002 proceeds with the following.

Function initialSelectOffer( ) of Ad Renderer 2002 makes the HTML Div “BlockB” visible using the CSS “display” attribute of HTML Div “BlockB” (refer to FIG. 23A). Next, function initialSelectOffer( ) of Ad Renderer 2002 gets a list of all checkboxes inside HTML Div “BlockA.” For each checkbox in the list of checkboxes, function initialSelectOffer( ) of Ad Renderer 2002 executes the following. If the “id” attribute of the checkbox starts with “offer_checkbox_,” the checkbox is an Offer Checkbox, and function initialSelectOffer( ) of Ad Renderer 2002 parses the “id” attribute value to obtain the number following the text “offer_checkbox_” (this number is the Offer id). If the checkbox is not selected by the consumer, function initialSelectOffer( ) of Ad Renderer 2002 uses the Offer id and fetches the Offer object using the associative array offers. Next, function initialSelectOffer( ) of Ad Renderer 2002 uses the Offer object and the “dom id” value of the Offer object to obtain the HTML Div “OfferBlock” for this Offer. Next, function initialSelectOffer( ) of Ad Renderer 2002 makes the HTML Div “Offer Block” for this Offer invisible using the CSS “display” attribute. If the checkbox is selected by the consumer, function initialSelectOffer( ) of Ad Renderer 2002 adds the Offer id to the selectOfferIDs list.

Next, function initialSelectOffer( ) of Ad Renderer 2002 checks the value of the type key in the associative array adOptions. The value of the type key is set to “Tower” for this Ad Unit, and when the value of the type key is set to “Tower,” function initialSelectOffer( ) of Ad Renderer 2002 performs the following.

Function initialSelectOffer( ) of Ad Renderer 2002 resizes HTML Div “BlockA” using the CSS “top” attribute of HTML Div “BlockA” so that it is below HTML Div “BlockB.” Also using the CSS “autoscrollbar” attribute, function initialSelectOffer( ) of Ad Renderer 2002 adds a scrollbar to HTML Div “BlockA.” Next, function initialSelectOffer( ) of Ad Renderer 2002 calls Ad Optimizer 2003 (through its web interface) and passes: (a) the value of the key dataSourceID in the associative array adOptions as the id of the Data Source Configuration; (b) a list of keywords describing the Publisher's website content; (c) the value of the key formNumOffers in the associative array adOptions (i.e., the number of offers to fetch); and (d) the selectedOfferIDs list of Offers that were selected (i.e., that had their checkbox enabled). Ad Optimizer 2003 stores the list of Offers that were selected in selectedOfferIDs (for example, and without limitation, User Offer Interaction Database 2009 shown in FIG. 20). Ad Optimizer 2003 returns Offers from a pool of Offers for the Advertiser that have not been selected (there is no point in showing the Offers that were already selected). For example, and without limitation, Ad Optimizer 2003 may select Offers to be returned: (a) by selecting a requested number of non-selected Offers without optimization (for example, the next non-selected Offers in the pool); or (b) by using one or more of the optimization techniques discussed above. Next, function initialSelectOffer( ) of Ad Renderer 2002 writes the returned Advertiser Offers inside the HTML Div “BlockA.” For each returned Advertiser Offer, function initialSelectOffer( ) of Ad Renderer 2002 executes the following. Function initialSelectOffer( ) of Ad Renderer 2002 creates a new Offer object, and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, function initialSelectOffer( ) of Ad Renderer 2002 creates a new entry in the associative array offers linking the Offer id to the Offer object. Next, function initialSelectOffer( ) of Ad Renderer 2002: (a) creates an HTML Div “OfferBlock”; (b) sets the “id” attribute of this HTML Div “OfferBlock” to the value of “dom id” of the Offer object created previously; and (c) inside this HTML Div “OfferBlock,” creates an HTML checkbox “OfferCheckbox” and a corresponding HTML Div “OfferCreativeBlock” that contains the Offer Creative (the Offer Creative typically consists of a piece of text referred to as Offer Copy and may also include an HTML Image). Next, function initialSelectOffer( ) of Ad Renderer 2002 sets the “id” attribute of the HTML checkbox “OfferCheckbox” to a value created by joining the text “offer_checkbox_” with the Offer id. Next, function initialSelectOffer( ) of Ad Renderer 2002 makes the HTML button “ButtonA” invisible using the CSS “display” attribute of HTML “ButtonA.” Next, as the value of the type key in adOptions is set to “Tower,” function initialSelectOffer( ) of Ad Renderer 2002 makes the HTML button “ButtonB” visible using the CSS “display” attribute of HTML button “ButtonB.”

Consumer Provides and Submits His/Her Information

The consumer enters his/her consumer information inside HTML form “FormB” (refer to FIG. 23A), and clicks on HTML button “ButtonB” (refer to FIG. 23A). On clicking HTML button “ButtonB,” the Publisher's web browser calls the registered “onclick” function submitForm( ) of Ad Renderer 2002 of HTML button “ButtonB.” The function submitForm( ) of Ad Renderer 2002 executes the following.

It executes the function validateForm( ) of Ad Renderer 2002 which executes the following. Function validateForm( ) checks that the consumer has entered information for all HTML input fields inside HTML form “FormB.” If the HTML input fields inside HTML form “FormB” include an Email field, the function validateForm( ) of Ad Renderer 2002 verifies that the value is a valid “Email” syntax. If the Publisher chooses to restrict consumers to be residents of a particular country, and the HTML input fields inside HTML form “FormB” include a Postal Code (for example, Zip Code in the United States) field, the function validateForm( ) of Ad Renderer 2002 verifies that the value is a valid “PostalCode” syntax for that country. An example of this would be to check if the “PostalCode” value is a 5 digit number if the country is the United States. If these checks do not pass, the JavaScript function alert( ) is called with a message informing the consumer that he/she has to correct a corresponding HTML input field, and the function validateForm( ) of Ad Renderer 2002 returns “false.” If all checks pass, the function validateForm( ) of Ad Renderer 2002 returns “true.”

Next, function submitForm( ) of Ad Renderer 2002 checks the return value of function validateForm( ) of Ad Renderer 2002. If the return value of function validateForm( ) of Ad Renderer 2002 is “false,” function submitForm( ) of Ad Renderer 2002 exits. If the return value of function validateForm( ) of Ad Renderer 2002 is “true,” the process continues with the following.

Function submitForm( ) of Ad Renderer 2002 creates an instance of data object 901 (refer to the Appendix and the Pontiflex Application). Next, function submitForm( ) of Ad Renderer 2002 gets a list of all HTML input elements inside HTML form “FormB.” Next, for each of the HTML input elements, function submitForm( ) of Ad Renderer 2002 adds a key and value pair in data object 901 (the key is the “name” attribute of the HTML input element and the value is the “value” attribute of the HTML input element). Next, for each of the HTML select elements, function submitForm( ) of Ad Renderer 2002 gets a list of HTML option elements inside the HTML select element. For each HTML option element, if the value of the selected attribute is set to “true,” function submitForm( ) of Ad Renderer 2002 adds a key and value pair in data object 901 (the key is the “name” attribute of the HTML select element and the value is the “value” attribute of the HTML option element). Next, function submitForm( ) of Ad Renderer 2002 obtains a list of all checkboxes inside HTML Div “BlockA.” For each checkbox in this list of checkboxes, function submitForm( ) of Ad Renderer 2002 executes the following. If the “id” attribute of the checkbox starts with “offer_checkbox_,” the checkbox is an Offer Checkbox. If the checkbox has been selected by the consumer, the following steps are executed. The “id” attribute value is parsed and the number following the text “offer_checkbox_” (this number is the Offer id) is obtained. This number is used to fetch the Offer object from the associative array offers. The value of “data transfer id” is obtained from the Offer object. A check is made to determine whether the Offer id exists in the selectedOfferIDs list; if it does not exist, the Offer id is added to the selectedOfferIDs list. Next, function submitForm( ) of Ad Renderer 2002 calls the JavaScript function component 902 of BrowserScriptPost code with the value of “data transfer id” and data object 901. The consumer data provided by the consumer's interacting with the Ad Unit is thus collected and passed to computer system 1000 for onward transfer by computer system 1000 to the data consumer (Advertiser) specified in the data transfer configuration corresponding to the value of “data transfer id.”

Next, the HTML Div “BlockB” is made invisible using the CSS “display” attribute of HTML Div “BlockB.” Next, as the value of the type key in the associative array adOptions is set to “Tower,” the HTML button “ButtonB” is made invisible using the CSS “display” attribute of HTML button “ButtonB.”

Next, the HTML Div “BlockC” is made visible using the CSS “display” attribute of HTML Div “BlockC” (refer to FIG. 23B). Next, the HTML button “ButtonC” is made visible using the CSS “display” attribute of HTML button “ButtonC” (refer to FIG. 23B). Next, function submitForm( ) of Ad Renderer 2002 checks the value of the type key in the associative array adOptions. The value of the type key is set to “Tower” for this Ad Unit, and when the value of the type key is set to “Tower,” function submitForm( ) of Ad Renderer 2002 performs the following steps.

Function submitForm( ) of Ad Renderer 2002 resizes HTML Div “BlockA” using the CSS “top” attribute of HTML Div “BlockA” so that it is below HTML Div “BlockC.” Next, the “OfferBlock” and “OfferCheckbox” HTML elements of offers which were selected by the consumer are made invisible using the CSS “display” attribute of the HTML “OfferCheckbox” and “OfferBlock” elements. Next, function submitForm( ) of Ad Renderer 2002 calls the web interface of Ad Optimizer 2003 (through its web interface) and passes: (a) the value of the key dataSourceID in the associative array adOptions as the id of the Data Source Configuration; (b) a list of keywords describing the Publisher's website content; (c) the value of afterFormNumOffers in the associative array adOptions (i.e., the number of further offers to fetch); and (d) the selectedOfferIDs list of Offers that were selected (i.e., that had their checkbox enabled). Next, function submitForm( ) of Ad Renderer 2002 writes the returned Advertiser Offers inside HTML Div “BlockA.” For each returned Advertiser Offer, function submitForm( ) of Ad Renderer 2002 executes the following.

Function submitForm( ) of Ad Renderer 2002 creates a new Offer object, and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, function submitForm( ) of Ad Renderer 2002 creates a new entry in the associative array offers linking the Offer id to the Offer object. Next, function submitForm( ) of Ad Renderer 2002: (a) creates an HTML Div “OfferBlock”; (b) sets the “id” attribute of this HTML Div “OfferBlock” to the value of “dom id” of the Offer object created previously; and (c) inside this HTML Div “OfferBlock,” creates an HTML checkbox “OfferCheckbox” and a corresponding HTML Div “OfferCreativeBlock” that contains the Offer Creative. Next, function submitForm( ) of Ad Renderer 2002 sets the “id” attribute of the HTML checkbox “OfferCheckbox” to a value created by joining the text “offer_checkbox_” with the Offer id.

Consumer Selects More Offers

The consumer can now select one or more Offers from HTML Div “Block A” (refer to FIG. 23B). On clicking HTML button “ButtonC,” the Publisher's web browser calls the registered “onclick” function resubmitForm( ) of Ad Renderer 2002 of HTML button “ButtonC.” The function resubmitForm( ) of Ad Renderer 2002 executes the following.

Function resubmitForm( ) of Ad Renderer 2002 gets a list of all checkboxes inside HTML Div “BlockA.” For each checkbox in this list of checkboxes, function resubmitForm( ) of Ad Renderer 2002 executes the following. If the “id” attribute of the checkbox starts with “offer_checkbox_,” the checkbox is an Offer checkbox. If the checkbox is selected by the consumer, the following steps are executed. The “id” attribute value is parsed, and the number following the text “offer_checkbox_” (this number is the Offer id) is obtained. This number is used to fetch the Offer object from the associative array offers. The value of “data transfer id” is obtained from the Offer object. A check is made to determine whether the Offer id exists in the selectedOfferIDs list; if it does not exist, the Offer id is added to the selectedOfferID list. Next, function resubmitForm( ) of Ad Renderer 2002 calls the JavaScript function component 902 of the BrowserScriptPost code (see the Appendix) with the value of “data transfer id” and data object 901. The consumer data provided by the consumer's interacting with the Ad Unit is thus collected and passed to computer system 1000 for onward transfer by computer system 1000 to the data consumer (Advertiser) specified in the data transfer configuration corresponding to the value of “data transfer id.”

Next, the “OfferBlock” and “OfferCheckbox” HTML elements of offers which were selected by the consumer are made invisible using the CSS “display” attribute of HTML “OfferCheckbox” and “OfferBlock” elements. Next, function resubmitForm( ) of Ad Renderer 2002 Ad Optimizer 2003 (through its web interface) and passes: (a) the value of the key dataSourceID in the associative array adOptions as the id of the Data Source Configuration; (b) a list of keywords describing the Publisher's website content; (c) the value of afterFormNumOffers in the associative array adOptions (the number of further offers to fetch); and (d) the selectedOfferIDs list of Offers that were selected (i.e., that had their checkbox enabled). Next, function resubmitForm( ) of Ad Renderer 2002 writes the returned Advertiser Offers inside the HTML Div “BlockA.” For each Advertiser Offer, function resubmitForm( ) of Ad Renderer 2002 executes the following.

Function resubmitForm( ) of Ad Renderer 2002 creates a new Offer object and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, function resubmitForm( ) of Ad Renderer 2002 creates a new entry in the associative array offers linking the Offer id to the Offer object. Next, function resubmitForm( ) of Ad Renderer 2002: (a) creates an HTML Div “OfferBlock”; (b) sets the “id” attribute of this HTML Div “OfferBlock” to the value of “dom id” of the Offer object created previously; and (c) inside this HTML Div “OfferBlock,” creates an HTML checkbox “OfferCheckbox” and a corresponding HTML Div “OfferCreativeBlock” that contains the Offer Creative. Next, function resubmitForm( ) of Ad Renderer 2002 sets the “id” attribute of the HTML checkbox “OfferCheckbox” to a value created by joining the text “offer_checkbox_” with the Offer id.

The consumer can continue to select one or more offers and click the HTML button “ButtonC,” and Ad Renderer 2002 will repeat the above steps for executing the function resubmitForm( ) of Ad Renderer 2002 call attached to the “onclick” attribute of HTML button “ButtonC.”

Square Ad Unit

If the value of the type key in the associative array adOptions placed on the Publisher's website or the Publisher's Ad Server is set to “Square,” the Ad Unit is rendered as a Square Ad Unit. By the nature of how an HTML Script tag works, the web browser will execute the JavaScript code inside Ad Loader 2001. In accordance with one or more embodiments of the present invention, Ad Loader 2001 checks the value of the type key in the associative array adOptions. If the value of the type key is set to “Square,” Ad Loader 2001 creates an HTML Iframe “Frame A” with a width and height specified in the associative array adOptions. Then, Ad Loader 2001 sets the “src” attribute of HTML Iframe “Frame A” to, for example and without limitation, to a company-hosted, for example and without limitation, a Pontiflex™, Inc.-hosted, URL which points to an HTML Page containing the JavaScript code for Ad Renderer 2002. The contents of the associative array adOptions are passed to this URL as HTTP GET parameters (where a parameter name is set to the key name in the associative array adOptions, and the value of the parameter is set to the value of the key in the associative array adOptions).

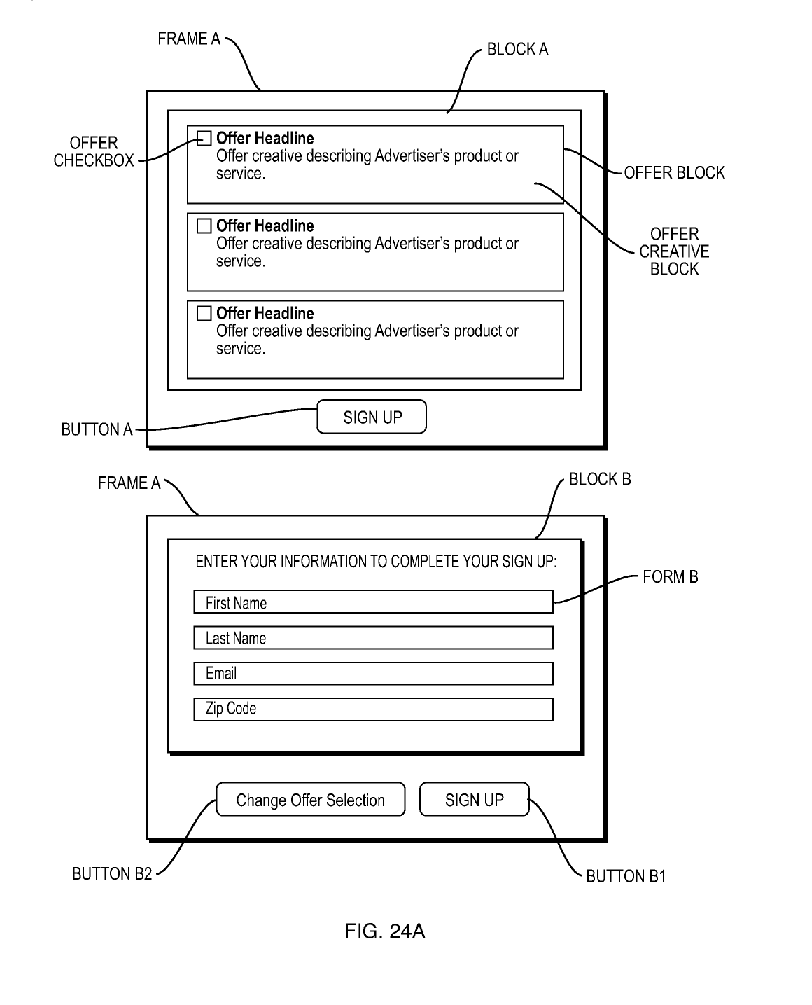

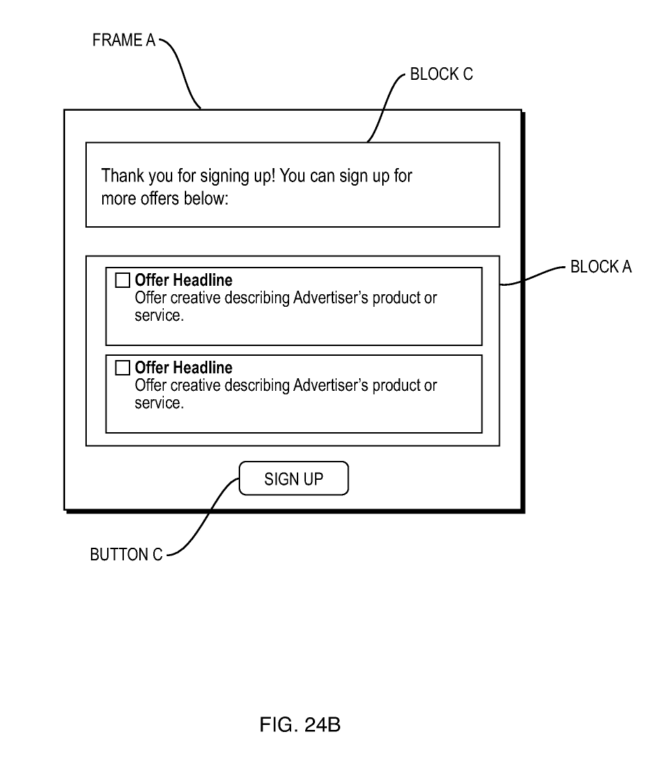

FIGS. 24A-24B show block diagrams used to describe how to create a visual layout of a Square Ad Unit, along with various components that are part of the Square Ad Unit, in accordance with one or more embodiments of the present invention. The sections below describe how these various components are created by Ad Renderer 2002, and how Ad Renderer 2002 responds to consumer interaction with the various components of the Square Ad Unit.

Initializing the Ad Unit

In accordance with one or more embodiments of the present invention, execution of the JavaScript code inside Ad Renderer 2002 first invokes the function drawAd( ). The function drawAd( ) executes the following.

The function drawAd( ) of Ad Renderer 2002 reads the HTTP GET parameters and recreates the associative array adOptions. For each HTTP GET parameter, the function drawAd( ) of Ad Renderer 2002 associates a key equal to the HTTP GET parameter name to a value equal to the HTTP GET parameter value. Next, the function drawAd( ) of Ad Renderer 2002 creates an HTML Div “Block A” (refer to FIG. 24A) inside the Iframe “FrameA” (refer to FIG. 24A). Next, the function drawAd( ) of Ad Renderer 2002 calls Ad Optimizer 2003 (through its web interface) and passes: (a) the value of the key dataSourceID in the associative array adOptions as the id of the Data Source Configuration, (b) a list of keywords representing the Publisher's website content, and (c) the value of key initNumOffers in the associative array adOptions as the number of offers to fetch. In response, the function drawAd( ) of Ad Renderer 2002 receives a list of Advertiser Offers in JSON format. Next, the function drawAd( ) of Ad Renderer 2002 writes various Advertiser Offers inside the HTML Div “BlockA” (refer to FIG. 24A). For each Advertiser Offer, the function drawAd( ) of Ad Renderer 2002 executes the following steps. The function drawAd( ) of Ad Renderer 2002 creates a new Offer object, and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, the function drawAd( ) of Ad Renderer 2002 creates a new entry in the associative array offers linking the Offer id to the Offer object. Next, the function drawAd( ) of Ad Renderer 2002: (a) creates an HTML Div “OfferBlock” (refer to FIG. 24A); (b) sets the “id” attribute of this HTML Div “OfferBlock” to the value of “dom id” of the Offer object created in the previous step; and (c) inside this HTML Div “OfferBlock,” creates an HTML checkbox “OfferCheckbox” (refer to FIG. 24A) and a corresponding HTML Div “OfferCreativeBlock” that contains the Offer Creative (refer to FIG. 24A). Next, the function drawAd( ) of Ad Renderer 2002 sets the “id” attribute of the HTML checkbox “OfferCheckbox” to a value created by joining the text “offer_checkbox_” with the Offer id.

Next, below the HTML Div “BlockA,” the function drawAd( ) of Ad Renderer 2002 creates an HTML button “ButtonA” (refer to FIG. 24A) and attaches a call to function initialSelectOffer( ) on the “onclick” event handler of HTML button “ButtonA.” Next, the function drawAd( ) of Ad Renderer 2002 creates an HTML Div “BlockB” (refer to FIG. 24A), and creates HTML form “FormB” (refer to FIG. 24A) inside Div “BlockB.” Next, inside “FormB,” the function drawAd( ) of Ad Renderer 2002 creates HTML input text fields for common fields, for example and without limitation: first name, last name, email and zip code (refer to FIG. 24A). Next, the function drawAd( ) of Ad Renderer 2002 makes HTML Div “BlockB” invisible using the CSS “display” attribute of HTML Div “BlockB.” Next, as the value of the type key in the associative array adOptions is set to “Square,” the function drawAd( ) of Ad Renderer 2002 creates an HTML button “ButtonB1” (refer to FIG. 24A) and attaches a call to function submitForm( ) to the “onclick” event handler of HTML button “ButtonB1”. Next, as the value of the type key in the associative array adOptions is set to “Square,” the function drawAd( ) of Ad Renderer 2002 makes HTML button “ButtonB1” invisible using the CSS “display” attribute of HTML button “ButtonB1.” Next, as the value of the type key in the associative array adOptions is set to “Square,” the function drawAd( ) of Ad Renderer 2002 creates an HTML button “ButtonB2” (refer to FIG. 24A) and attaches a call to function backToOfferSelection( ) to the “onclick” event handler of HTML button “ButtonB2.” Next, as the value of the type key in adOptions is set to “Square,” the function drawAd( ) of Ad Renderer 2002 makes HTML button “ButtonB2” invisible using the CSS “display” attribute of HTML button “ButtonB2.” Next, the function drawAd( ) of Ad Renderer 2002 creates a HTML Div “BlockC” (refer to FIG. 24B) which contains text that is to be displayed to the consumer at the end of the consumer's submitting consumer data in HTML form “FormB.” This text typically consists of a message thanking the consumer for submitting his/her information in HTML form “Form B” (refer to FIG. 24B). Next, the function drawAd( ) of Ad Renderer 2002 makes HTML Div “BlockC” invisible using the CSS “display” attribute of HTML Div “BlockC.” Next, the function drawAd( ) of Ad Renderer 2002 creates an HTML button “ButtonC” (refer to FIG. 24B) having the same position as HTML button “ButtonA,” and attaches a call to function resubmitForm( ) function to the “onclick” event handler of HTML button “ButtonC.” Next, the function drawAd( ) of Ad Renderer 2002 makes HTML button “ButtonC” invisible using the CSS “display” attribute of HTML button “ButtonC.”

Capturing Consumer Interaction with Ad Unit

FIGS. 18A-18B show block diagrams used to describe a consumer's interaction with a Square Ad Unit that is fabricated in accordance with one or more embodiments of the present invention. As shown in FIG. 18A, the consumer views the Ad Unit on a Publisher's web page, reviews the various Advertisers' Offers, and if interested, selects one or more than one of those offers by selecting the checkbox or checkboxes next to the Advertisers' Offers (refer to box 7001 of FIG. 18A). When the consumer has selected one or more offers, he/she clicks a submit button (refer to box 7002 of FIG. 18A). Upon clicking the submit button, a data entry form is displayed in the banner Ad Unit. The consumer completes the fields in the data entry form, and clicks a submit button to finish (refer to box 7003 of FIG. 18A). Upon clicking the submit button, the consumer is presented with an acknowledgement message thanking him/her for signing up (refer to box 7005 of FIG. 18B) (Alternatively, by clicking a “change offer selection” button, the Ad Unit changes back to the previous view) (refer to box 7004 of FIG. 18B)). At this point, additional offers may also be displayed in the banner Ad Unit. The consumer may select one or more of the additional offers by selecting the checkbox or checkboxes next to the Advertisers' Offers and clicking a submit button (refer to box 7006 of FIG. 18B). At this point, additional offers may be displayed in the banner Ad Unit (refer to box 7007 of FIG. 18B).

Initial Selection of Offers by Consumer

After an Ad Unit has been initialized, a consumer interacts with the Ad Unit by selecting one or more checkboxes inside HTML Div “Block A” (refer to FIG. 24A), and clicking on HTML button “ButtonA” (refer to FIG. 24A). On clicking on HTML button “ButtonA,” the Publisher's web browser calls the registered “onclick” function initialSelectOffer( ) of Ad Renderer 2002 of HTML button “ButtonA.” The function initialSelectOffer( ) of Ad Renderer 2002 executes the following.

Function initialSelectOffer( ) of Ad Renderer 2002 fetches a list of all checkboxes inside HTML Div “BlockA,” and checks if at least one of the checkboxes has been selected. If none of the checkboxes has been selected, it calls JavaScript function alert with a message informing the consumer that he/she has to select at least one offer inside HTML Div “BlockA.” After that. the function initialSelectOffer( ) of Ad Renderer 2002 exits. If at least one of the checkboxes has been selected, the function initialSelectOffer( ) of Ad Renderer 2002 proceeds with the following.

Function initialSelectOffer( ) of Ad Renderer 2002 gets a list of all checkboxes inside HTML Div “BlockA.” For each checkbox in this list of checkboxes, function initialSelectOffer( ) of Ad Renderer 2002 executes the following. If the “id” attribute of the checkbox starts with “offer_checkbox_,” the checkbox is an Offer Checkbox, and function initialSelectOffer( ) of Ad Renderer 2002 parses the “id” attribute value and to obtain the number following the text “offer_checkbox_” (this number is the Offer id). If the checkbox is selected by the consumer, function initialSelectOffer( ) of Ad Renderer 2002 adds the Offer id to the selectOfferIDs list.

Next, function initialSelectOffer( ) of Ad Renderer 2002 checks the value of the type key in the associative array adOptions. The value of the type key is set to “Square” for this Ad Unit, and when the value of the type key is set to “Square,” function initialSelectOffer( ) of Ad Renderer 2002 performs the following.

Function initialSelectOffer( ) of Ad Renderer 2002 makes the HTML Div “BlockA” invisible using the CSS “display” attribute of HTML Div “BlockA.” Next, function initialSelectOffer( ) of Ad Renderer 2002 makes the HTML button “ButtonA” invisible using the CSS “display” attribute of HTML “ButtonA.” Next, Function initialSelectOffer( ) of Ad Renderer 2002 makes the HTML Div “BlockB” visible using the CSS “display” attribute of HTML Div “BlockB” (refer to FIG. 24A). Next, as the value of the type key in the associative array adOptions is set to “Square,” function initialSelectOffer( ) of Ad Renderer 2002 makes the HTML button “ButtonB1” visible using the CSS “display” attribute of HTML button “ButtonB1.” Next, as the value of the type key in the associative array adOptions is set to “Square,” function initialSelectOffer( ) of Ad Renderer 2002 makes the HTML button “ButtonB2” visible using the CSS “display” attribute of HTML button “ButtonB2.”

Consumer Clicks HTML Button “ButtonB2”

When the consumer clicks HTML button “ButtonB2,” the Publisher's web browser calls the registered “onclick” function backToOfferSelection( ) of Ad Renderer 2002 of HTML button “ButtonB2.” The function backToOfferSelection( ) of Ad Renderer 2002 executes the following.

Function backToOfferSelection( ) of Ad Renderer 2002 makes HTML Block “BlockB” invisible using the CSS “display” attribute of HTML button “BlockB.” Next, function backToOfferSelection( ) of Ad Renderer 2002 makes HTML button “ButtonB1” invisible using the CSS “display” attribute of HTML button “ButtonB1.” Next, function backToOfferSelection( ) of Ad Renderer 2002 makes HTML button “ButtonB2” invisible using the CSS “display” attribute of HTML button “ButtonB2.” Next, function backToOfferSelection( ) of Ad Renderer 2002 makes HTML Block “BlockA” visible using the CSS “display” attribute of HTML Block “BlockA.” Next, function backToOfferSelection( ) of Ad Renderer 2002 makes HTML button “ButtonA” visible using the CSS “display” attribute of HTML Block “ButtonA.” After the function backToOfferSelection( ) of Ad Renderer 2002 has finished execution, the Ad Unit is restored back to the state it was in after the Ad Unit was first initialized.

Consumer Provides and Submits His/Her Information

The consumer enters his/her consumer information inside HTML form “FormB” and clicks on HTML button “ButtonB1” (refer to FIG. 24A). On clicking HTML button “ButtonB1,” the Publisher's web browser calls the registered “onclick” function submitForm( ) of Ad Renderer 2002 of HTML button “ButtonB1.” The function submitForm( ) of Ad Renderer 2002 executes the following.

It executes the function validateForm( ) of Ad Renderer 2002 which executes the following. Function validateForm( ) of Ad Renderer 2002 checks that the consumer has entered information for all HTML input fields inside HTML form “FormB.” If the HTML input fields inside HTML form “FormB” include an Email field, the function validateForm( ) of Ad Renderer 2002 verifies that the value is a valid “Email” syntax. If the Publisher chooses to restrict consumers to be residents of a particular country, and the HTML input fields inside HTML form “FormB” consists of a Postal Code field, the function validateForm( ) of Ad Renderer 2002 verifies that the value is a valid “PostalCode” syntax for that country. An example of this would be to check if the “PostalCode” value is a 5 digit number if the country is United States. If these checks do not pass, the JavaScript function alert( ) is called with a message informing the consumer that he/she has to correct a corresponding HTML input field, and the function validateForm( ) of Ad Renderer 2002 returns “false.” If all checks pass, the function validateForm( ) of Ad Renderer 2002 returns “true.”

Next, the function submitForm( ) of Ad Renderer 2002 checks the return value of the function validateForm( ) of Ad Renderer 2002. If return value is “false,” function submitForm( ) of Ad Renderer 2002 exits. If the return value of function validateForm( ) of Ad Renderer 2002 is true,” the process continues with the following.

Function submitForm( ) of Ad Renderer 2002 creates an instance of data object 901 (refer to the Appendix and the Pontiflex Application). Next, function submitForm( ) of Ad Renderer 2002 gets a list of all HTML input elements inside HTML form “FormB.” Next, for each of the HTML input elements, function submitForm( ) of Ad Renderer 2002 adds a key and value pair in data object 901 (the key is the “name” attribute of the HTML input element and the value is the “value” attribute of the HTML input element). Next, for each of the HTML Select elements, function submitForm( ) of Ad Renderer 2002 gets a list of HTML option elements inside the HTML select element. For each HTML option element, if the value of the HTML option element “selected” is set to “true,” function submitForm( ) of Ad Renderer 2002 adds a key and value pair in data object 901 (the key is the “name” attribute of the HTML select element and the value is the “value” attribute of the HTML option element). Next, function submitForm( ) of Ad Renderer 2002 obtains a list of all checkboxes inside HTML Div “BlockA.” For each checkbox in this list of checkboxes, function submitForm( ) of Ad Renderer 2002 executes the following. If the “id” attribute of the checkbox starts with “offer_checkbox_,” the checkbox is an Offer Checkbox. If the checkbox has been selected by the consumer, the following steps are executed. The “id” attribute value is parsed and the number following the text “offer_checkbox_” (this number is the Offer id) is obtained. This number is used to fetch the Offer object from the associative array offers. The value of “data transfer id” is obtained from the Offer object. A check is made to determine whether the Offer id exists in the selectedOfferIDs list; if it does not exist, the Offer id is added to the selectedOfferIDs list. Next, function submitForm( ) of Ad Renderer 2002 calls the JavaScript function component 902 of the BrowserScriptPost code with the value of “data transfer id” and data object 901. The consumer data provided by the consumer's interacting with the Ad Unit is thus collected and passed to computer system 1000 for onward transfer by computer system 1000 to the data consumer (Advertiser) specified in the data transfer configuration corresponding to the value of “data transfer id.”

Next, the HTML Div “BlockB” is made invisible using the CSS “display” attribute of HTML Div “BlockB.” Next, as the value of the type key in the associative array adOptions is set to “Square,” the HTML button “ButtonB1” is made invisible using the CSS “display” attribute of HTML button “ButtonB1.” Next, as the value of the type key in the associative array adOptions is set to “Square,” the HTML button “ButtonB2” is made invisible using the CSS “display” attribute of HTML button “ButtonB2.”

Next, the HTML Div “BlockC” is made visible using the CSS “display” attribute of HTML Div “BlockC” (refer to FIG. 24B). Next, the HTML button “ButtonC” is made visible using the CSS “display” attribute of HTML button “ButtonC” (refer to FIG. 24B). Next, function submitForm( ) of Ad Renderer 2002 checks the value of the type key in the associative array adOptions. The value of the type key is set to “Square” for this Ad Unit, and when the value of the type key is set to “Square,” function submitForm( ) of Ad Renderer 2002 performs the following.

Function submitForm( ) of Ad Renderer 2002 resizes HTML Div “BlockA” using the CSS “top” attribute of HTML Div “BlockA” so that it is below HTML Div “BlockC.” Next, the HTML Div “BlockA” is made visible using the CSS “display” attribute of HTML Div “BlockA.” Next, the “OfferBlock” and “OfferCheckbox” HTML elements of offers which were selected by the consumer are made invisible using the CSS “display” attribute of the HTML “OfferCheckbox” and “OfferBlock” elements. Next, function submitForm( ) of Ad Renderer 2002 Ad Optimizer 2003 (through its interface) and passes: (a) the value of the key dataSourceID in the associative array adOptions as the id of the Data Source Configuration; (b) a list of keywords describing the Publisher's website content; (c) the value of afterFormNumOffers in the associative array adOptions (i.e., the number of further offers to fetch); and (d) the selectedOfferIDs list of Offers that were selected (i.e., that had their checkbox enabled). Next, function submitForm( ) of Ad Renderer 2002 writes the returned Advertiser Offers inside the HTML Div “BlockA.” For each returned Advertiser Offer, function submitForm( ) of Ad Renderer 2002 executes the following.

Function submitForm( ) of Ad Renderer 2002 creates a new Offer object, and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, function submitForm( ) of Ad Renderer 2002 creates a new entry in the associative array offers linking the Offer id to the Offer object. Next, function submitForm( ) of Ad Renderer 2002: (a) creates an HTML Div “OfferBlock”; (b) sets the “id” attribute of this HTML Div “OfferBlock” to the value of “dom id” of the Offer object created previously; and (c) inside this HTML Div “OfferBlock,” creates an HTML checkbox “OfferCheckbox” and a corresponding HTML Div “OfferCreativeBlock” that contains the Offer Creative. Next, function submitForm( ) of Ad Renderer 2002 sets the “id” attribute of the HTML checkbox “OfferCheckbox” to a value created by joining the text “offer_checkbox_” with the Offer id.

Consumer Selects More Offers

The consumer can now select one or more Offers from HTML Div “Block A” (refer to FIG. 24B). On clicking on HTML button “ButtonC,” the Publisher's web browser calls the registered “onclick” function resubmitForm( ) of Ad Renderer 2002 of HTML button “ButtonC.” The function resubmitForm( ) of Ad Renderer 2002 executes the following.

Function resubmitForm( ) of Ad Renderer 2002 gets a list of all checkboxes inside HTML Div “BlockA.” For each checkbox in this list of checkboxes, function resubmitForm( ) of Ad Renderer 2002 executes the following. If the “id” attribute of the checkbox starts with “offer_checkbox_,” the checkbox is an Offer checkbox. If the checkbox is selected by the consumer, the following steps are executed. The “id” attribute value is parsed and the number following the text “offer_checkbox_” is obtained (this number is the Offer id). This number is used to fetch the Offer object from the associative array offers. The value of the “data transfer id” is obtained from the Offer object. A check is made to determine whether the Offer id exists in the selectedOfferIDs list; if it does not exist, the Offer id is added to the selectedOfferID list. Next, function resubmitForm( ) of Ad Renderer 2002 calls the JavaScript function component 902 of the BrowserScriptPost code with the value of “data transfer id” and data object 901. The consumer data provided by the consumer's interacting with the Ad Unit is thus collected and passed to computer system 1000 for onward transfer by computer system 1000 to the data consumer (Advertiser) specified in the data transfer configuration corresponding to the value of “data transfer id”.

Next, the “OfferBlock” and “OfferCheckbox” HTML elements of offers which were selected by the consumer are made invisible using the CSS “display” attribute of the HTML “OfferCheckbox” and “OfferBlock” elements. Next, function resubmitForm( ) of Ad Renderer 2002 Ad Optimizer 2003 (through its web interface) and passes: (a) the value of the key dataSourceID in the associative array adOptions as the id of the Data Source Configuration, (b) a list of keywords describing the Publisher's website content, (c) the value of afterFormNumOffers in the associative array adOptions (the number of further offers to fetch); and (d) the selectedOfferIDs list that were selected (i.e., that had their checkbox enabled). Next, function resubmitForm( ) of Ad Renderer 2002 writes the returned Advertiser Offers inside the HTML Div “BlockA.” For each Advertiser Offer, function resubmitForm( ) of Ad Renderer 2002 executes the following.

Function resubmitForm( ) of Ad Renderer 2002 creates a new Offer object and sets: (a) the value of “data transfer id” in the Offer object to the Pontiflex™ Data Transfer Id for the Advertiser Offer; and (b) the value of “dom id” in the Offer object to a value created by joining the text “offer_” with the Offer id. Next, function resubmitForm( ) of Ad Renderer 2002 creates a new entry in the associative array offers linking the Offer id to the Offer object. Function resubmitForm( ) of Ad Renderer 2002: (a) creates an HTML Div “OfferBlock”; (b) sets the “id” attribute of this HTML Div “OfferBlock” to the value of “dom id” of the Offer object created previously; and (c) inside this HTML Div “OfferBlock”, creates an HTML checkbox “OfferCheckbox” and a corresponding HTML Div “OfferCreativeBlock” that contains the Offer Creative. Next, function resubmitForm( ) of Ad Renderer 2002 sets the “id” attribute of the HTML checkbox “OfferCheckbox” to a value created by joining the text “offer_checkbox_” with the Offer id.

The consumer can continue to select one or more offers and click HTML button “Button C,” and Ad Renderer 2002 will repeat the above steps for executing the function resubmitForm( ) of Ad Renderer 2002 call attached to the “onclick” attribute of HTML button “Button C.”

Embodiments of the present invention described above are exemplary. As such, many changes and modifications may be made to the description set forth above by those of ordinary skill in the art while remaining within the scope of the invention. As such, the scope of the invention should be determined with reference to the appended claims along with their full scope of equivalents.

### APPENDIX

### The Pontiflex™ Data Transfer System

One or more embodiments of the present invention utilize a computer system that provides a data bridge connecting Publishers (a Publisher is also referred to herein as a “data source”), for example and without limitation, online Publishers, to Advertisers (an Advertiser is also referred to herein as a “data consumer”), for example and without limitation, online Advertisers, to transfer data between them. In particular, in accordance with one or more such embodiments, the computer system mediates data transfers so that data sources can connect to the computer system in their preferred data transfer protocols to send data, and data consumers can build their connections to the computer system in their preferred data transfer protocols to receive the data. As such, in accordance with one or more such embodiments, by converting data received from data sources into data sent to data consumers, the computer system can provide: (a) a flexible data bridge that enables simple connectivity between parties; (b) immediate delivery of customer data and lowered cost of doing business; and (c) greater value for data being transferred. As will be described below, the computer system integrates online data transfers (typically comprised of data provided by customers such as, for example and without limitation, name, email address, zip code, credit card number, or other information) between Publishers and Advertisers using a set up process. Once the set up process is complete, the computer system can translate data received from a Publisher (i.e., a data source) and send the data to an Advertiser (i.e., a data consumer) by automatically recognizing the data output format provided by the Publisher and converting that information into the data input format required by the Advertiser. In addition, the computer system can archive the data for backup purposes, and all transfer statistics and metrics can be viewed by consumers via a web interface. In accordance with one or more such embodiments, the computer system and its method of operation can enable (and advantageously can simplify) data transfer between data sources and data consumers via, for example and without limitation, open data transfer protocols. In accordance with one or more such embodiments, the data transferred may be in the form of a data structure, for example and without limitation, a data structure in tabular form consisting of one or more rows, with each row consisting of one or more columns (fields). In accordance with one or more such embodiments, the computer system can automatically guess and map each Advertiser data field to a Publisher data field using string matching algorithms to compare and match data field names. Advantageously, this enables Publishers and Advertisers to skip an intermediate step of manually matching and connecting Advertiser and Publisher lists of fields, and reduces the number of steps to set up a data transfer in the computer system. In accordance with one or embodiments, the computer system and its described method of operation can provide the following capabilities: (a) a web-enabled interface (for example and without limitation, a form) for use by consumers to sign up for services rendered by the computer system; (b) a web-enabled interface (for example and without limitation, a form) to set up data source configurations that specify (i) data transfer protocols used to transfer data from a data source to the computer system, and (ii) data fields that make up each record of data received from the data source; (c) a web-enabled interface (for example and without limitation, a form) to set up data consumer configurations that specify (i) data transfer protocols used to transfer data from the computer system to a data consumer, and (ii) data transfer fields that make up each record of data to be sent to the data consumer; and (d) a web-enabled interface (for example and without limitation, a form) to set up data transfer configurations that specify (i) whether the computer system will pull data from a data source or the data source will push data to the computer system, (ii) where the data source will push data to the computer system, the computer system will create a data storage area for the data transfer, and, if required by the data transfer protocol (specified in the data source configuration), will generate credentials to access the data storage area, (iii) where the computer system will pull data from the data source, the data store information and credentials required by the computer system to access a data store created by the data source, (iv) whether the computer system will push data to a data consumer or the data consumer will pull the data from computer system, (v) where the data consumer will pull data from the computer system, the computer system will create a data storage area for the data transfer, and if required by the data transfer protocol (as specified in data consumer configuration), generate credentials to access the data storage area, (vi) where the computer system will push data to the data consumer, the data store information and credentials required by the computer system to access the data storage area created by the data consumer, and (vii) the computer system will automatically match the list data fields to be sent to the data consumer to the list of data fields received from the data source and will provide a web-based form to have the consumer verify and manually correct any mismatches between the two sets of data fields. In particular, one embodiment is a data bridge between Publishers and Advertisers for sending data from a Publisher to an Advertiser, which data bridge comprises: a computer system, which computer system includes: (a) a data consumer configurator; (b) a data source configurator; (c) a configuration data store; (d) a data transfer configurator; (e) a data transfer scheduler; (f) a data transfer engine; (g) a primary data store; (h) a tracking and billing component; and (i) an archiver.

FIG. 1 is a block diagram of a system architecture of computer system 1000. As shown in FIG. 1, computer system 1000 comprises data consumer (or Advertiser export) configurator 100, data source (or Publisher import) configurator 200, configuration data store 250, data transfer configurator 300, data transfer scheduler 400, data transfer engine 500, primary (or main lead) data store 600, tracking and billing component 700, and archiver 800. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 are combinations of software modules and computer hardware that provide functionality that will be described in detail below. Certain parts of the description below refer to a data source and a data consumer having web access to computer system 1000. In accordance with one or more embodiments, this is done by a data source and a data consumer first going to a website of a company (for example, Pontiflex, Inc.) running computer system 1000 and registering for an account. Registration may be done, for example and without limitation, by providing registration credentials such as, for example and without limitation, a name, email address, mailing address, and perhaps other contact information. The registration credentials are reviewed by the company (for example, Pontiflex, Inc.) staff, and, provided they are judged to be valid in accordance with company criteria, the company staff creates an account for the consumer and sends login credentials (for example, consumer ID and password) to the consumer via email or telephone. Consumers then can go to the company's website and click a “Log In” button and use these credentials to log in to computer system 1000. In accordance with one or more further embodiments, consumers can create their own accounts without prior approval by company staff. In accordance with one or more such embodiments, upon submitting their credentials, computer system 1000 automatically creates and presents a password and consumer name for the registrant after they register. However, in either case, company staff have an option to disable a consumer account of consumer immediately via computer system 1000.

Data Consumer Section

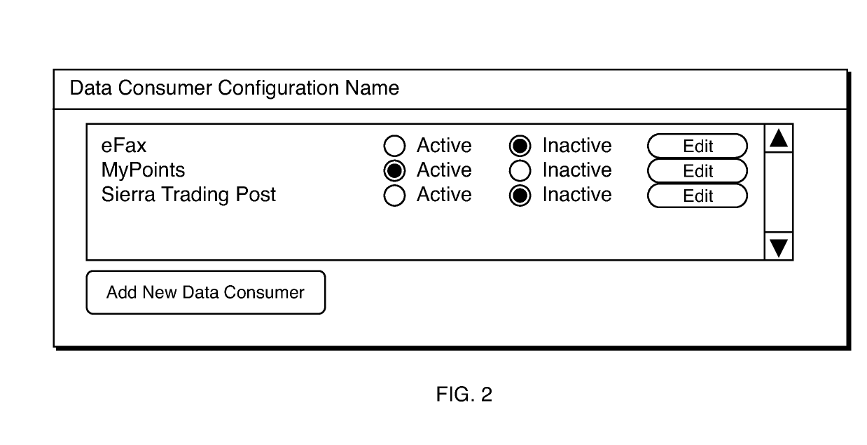

FIGS. 2-4 show screens used to describe data consumer configurator 100 that is fabricated in accordance with one or more embodiments to help one of ordinary skill in the art understand how to make and use computer system 1000. In accordance with one or more embodiments, data consumer configurator 100 is a module of computer system 1000 that exposes an interface, for example and without limitation, a web interface, in accordance with any one of a number of methods that are well known to those of ordinary skill in the art, wherein a data consumer can specify parameters required to receive data from computer system 1000. In accordance with one or more embodiments, the data consumer uses the interface as a set up tool, for example and without limitation, as a one-time set up tool, to specify configuration data (also referred to herein as a “configuration”) relating, among other things, to how computer system 1000 will send data to the data consumer. In accordance with one or more embodiments, the data consumer will need to change its configuration data only if it makes changes, for example and without limitation, in the way it wants or needs to receive data from computer system 1000. In addition, in accordance with one or more embodiments, a data consumer, if it chooses, can specify multiple configurations, for example and without limitation, one configuration for each different method of receiving data from computer system 1000. As will be described in detail below, the interface will provide web pages: (a) listing all existing configurations; (b) listing options to edit existing configurations; and (c) enabling addition of new configurations.

For a data consumer to initiate a new data consumer configuration or to edit an existing one, the data consumer accesses a web interface exposed by data consumer configurator 100 by clicking on a link to the web interface in a browser. In response, data consumer configurator 100 queries configuration data store 250 to retrieve all existing data consumer configurations set up by the data consumer previously (in accordance with any one of a number of methods that are well known to those of ordinary skill in the art), and data consumer configurator 100 displays this data as a list in the screen shown in FIG. 2 (in accordance with any one of a number of methods that are well known to those of ordinary skill in the art). As shown in the screen shown in FIG. 2, and in accordance with one or more embodiments, each data consumer configuration has a name, and a flag (“Active” or “Inactive”) used to indicate to data transfer engine 500 that the data consumer will accept data according to the format and method specified by this data consumer configuration. In addition, as shown in the screen shown in FIG. 2, an “Edit” button is displayed next to each data consumer configuration (in accordance with any one of a number of methods that are well known to those of ordinary skill in the art) to allow the data consumer to edit the data consumer configuration. In addition, an “Add New Data Consumer” button is displayed to enable the data consumer to create a new data consumer configuration.

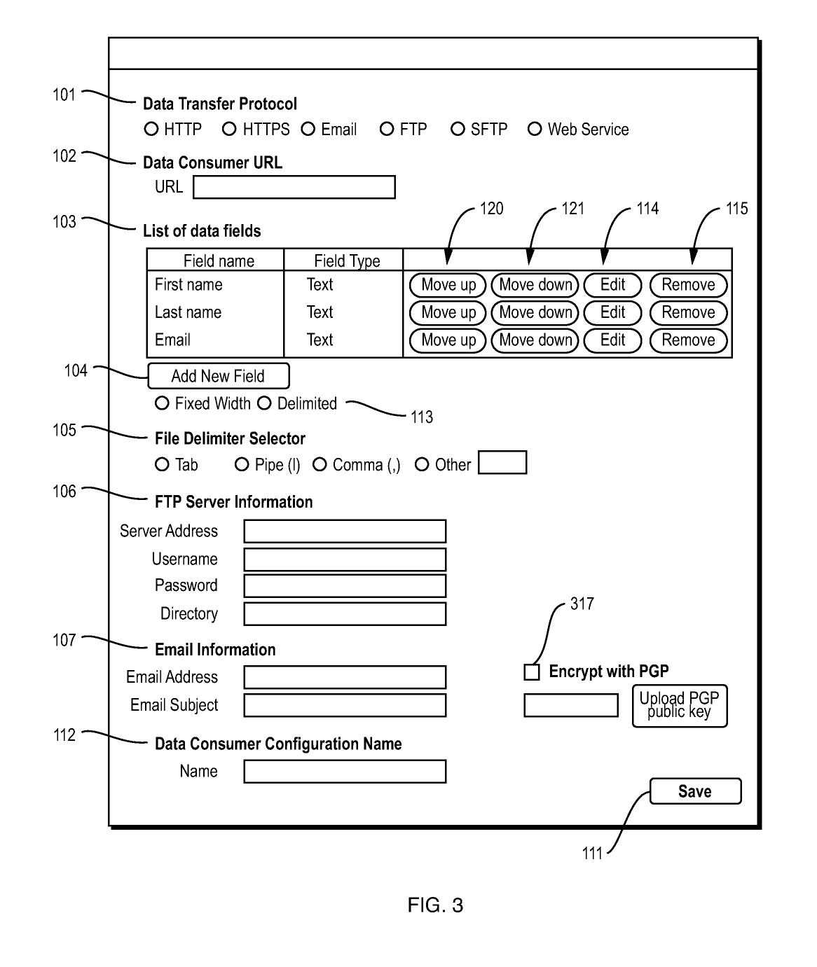

In response to the data consumer's clicking the “Edit” button on the screen shown in FIG. 2, in accordance with one or more embodiments, data consumer configurator 100 presents the screen shown in FIG. 3, pre-populated with the selected data consumer configuration information (in accordance with any one of a number of methods that are well known to those of ordinary skill in the art). In response to the data consumer's clicking the “Add New Data Consumer” button on the screen shown in FIG. 2, in accordance with one or more embodiments, data consumer configurator 100 presents the screen shown in FIG. 3 (in accordance with any one of a number of methods that are well known to those of ordinary skill in the art). FIG. 3 illustrates an instance of a data consumer configuration with Data Transfer Protocol selector 101, Data Consumer URL form 102, List of data fields 103, “Add New Field” button 104, File Delimiter Selector 105, optional FTP Server Information form 106, optional Email Information form 107, and Data Consumer Configuration Name 112. Based on consumer selection from Data Transfer Protocol selector 101, data consumer configurator 100 will conditionally display Data Consumer URL form 102, File Delimiter Selector 105, FTP Server Information form 106, or Email Information form 107. For example, if the consumer selects HTTP or HTTPS from Data Transfer Protocol selector 101, Data Consumer URL form 102 is displayed and File Delimiter Selector 105, FTP Server Information form 106, and Email Information form 107 are not displayed. However, if the consumer selects FTP or SFTP from Data Transfer selector 101, then File Delimiter Selector 105 and FTP Server Information form 106 are displayed, and Data Consumer URL form 102 and Email Information form 107 are not displayed. Lastly, if the consumer selects Email from Data Transfer Selector 101, then File Delimiter Selector 105 and Email Information form 107 are displayed, and Data Consumer URL form 102 and FTP Server Information form 106 are not displayed.

Data Transfer Protocol selector 101 specifies the data transfer protocol that must be used for the data consumer to accept data from computer system 1000. In accordance with one or more embodiments, data consumer configurator 100 displays a list of data transfer protocols (for example and without limitation, FTP, RCP, SFTP, SCP, HTTP, HTTPS, and SOAP via Web Service) from which the data consumer may choose. Data Consumer URL form 102 is the data consumer's web URL which computer system 1000 will use to transfer data to the data consumer if the data consumer selects to transfer data using HTTP or HTTPS POST. List of data fields 103 specifies the data fields that make up a single data record of the data transfer to the data consumer. In accordance with one or more embodiments, on the screen shown in FIG. 3, the data consumer will specify: (a) in case the consumer selects FTP or Email for data transfer protocol, the required ordering of data fields (as shown in the screen shown in FIG. 3) within each row of data (in accordance with one or more embodiments, the data consumer specifies the ordering of data fields by clicking on “Move up” button 120 or “Move down” button 121); (b) data fields to be removed from list of data fields 103 by clicking on “Remove” button 115; and (c) whether to have data fields in fixed-width format or to have data fields be delimited by a chosen character using selector 113. If the data consumer chooses to use delimited data fields by selecting a “Delimited” option for selector 113 on the screen shown in FIG. 3, the data consumer will specify a delimiter character using File Delimiter Selector 105. File Delimiter Selector 105 specifies the delimiter character that will be used to separate the data fields. File Delimiter Selector 105 will be shown only if the data consumer elects to transfer data using FTP or SFTP or email data transfer protocols. The delimiter character can be, for example and without limitation, comma (,), tab (\t), pipe (|), or any other single character of the data consumer's choice (in accordance with any one of a number of methods that are well known to those of ordinary skill in the art).

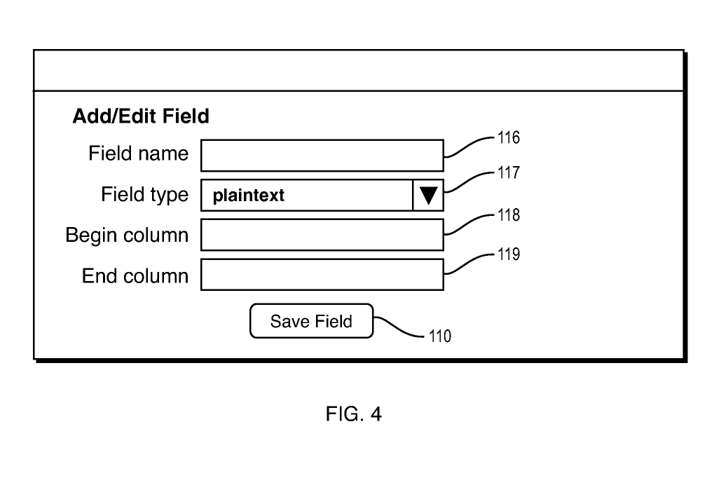

FTP Server Information form 106 includes the FTP server address, FTP server consumername and password, and FTP directory name that will be used by computer system 1000 to transfer data to the data consumer if the data consumer elects to transfer data using FTP or SFTP. Email Information form 107 includes the email addresses and email subject that will be used by computer system 1000 to transfer data to the data consumer if the data consumer elects to transfer data using Email. If the data consumer clicks on “Add New Field” button 104, data consumer configurator 100 will display the screen shown in FIG. 4.

To use the screen shown in FIG. 4, the data consumer will enter a field name in Field name 116, and select a field type using Field type 117. If the data consumer chooses to use a fixed width format by selecting a “Fixed width” option from selector 113 on the screen shown in FIG. 3, data consumer configurator 100 will present a begin column number in Begin column 118 and an end column number in End column 119 for the new field on the screen shown in FIG. 4. The data consumer selects a field type from an existing list of field types in Field type 117 to identify the format of the data field to computer system 1000, examples of field types include text, number, date, phone number, country code, state, zip. After the data consumer clicks “Save field” button 110 on the screen shown in FIG. 4, the data consumer configurator 100 adds the field name to the data consumer configuration, and the new field is displayed on list of fields 103 on the screen shown in FIG. 3. If the data consumer clicks on “Edit” button 114 on the screen shown in FIG. 3, data consumer configurator 100 displays the screen shown in FIG. 4 pre-populated with the selected field name in Field name 116, and a field type in Field type 117. In addition, if the data consumer selects the “Fixed Width” option from selector 113 on the screen shown in FIG. 3, data consumer configurator 100 displays a begin column number in Begin column 118 and an end column number in End column 119 on the screen shown in FIG. 4. After the data consumer clicks on “Save Field” button 110 on the screen shown in FIG. 4, the data consumer configurator 100 stores the changes to the field, and the changes are reflected in List of data fields 103 on the screen shown in FIG. 3. In accordance with one or more embodiments of, the data consumer can choose to receive files securely by having computer system 1000 send files encrypted using the data consumer's PGP key. To do this, the data consumer will select “Encrypt with PGP” checkbox 317 on the screen shown in FIG. 3, and enter an address of a file containing the PGP public key or browse its own system (in accordance with any one of a number of methods that are well known to those of ordinary skill in the art) to find the PGP public key file. In response, data consumer configurator 100 will upload the data consumer's PGP public key, and store it in configuration data store 250. Later, computer system 1000 will use the data consumer's PGP public key to encrypt files to be transferred to the data consumer.

The data consumer enters a human-readable name in Data Consumer Configuration Name form 112 to identify the data consumer configuration in data consumer configurator 100. After entering the required information on the screen shown in FIG. 3, the data consumer clicks on “Save” button 111 to save the data consumer configuration to configuration data store 250.

In accordance with one or more embodiments, data consumer configurator 100 stores the data consumer configuration in machine-readable format (for example and without limitation, in XML or as normalized database tables) in configuration data store 250 (in accordance with any one of a number of methods that are well known to those of ordinary skill in the art). The data components comprising the data consumer configuration are set forth in detail in FIG. 13.

Data Source Section

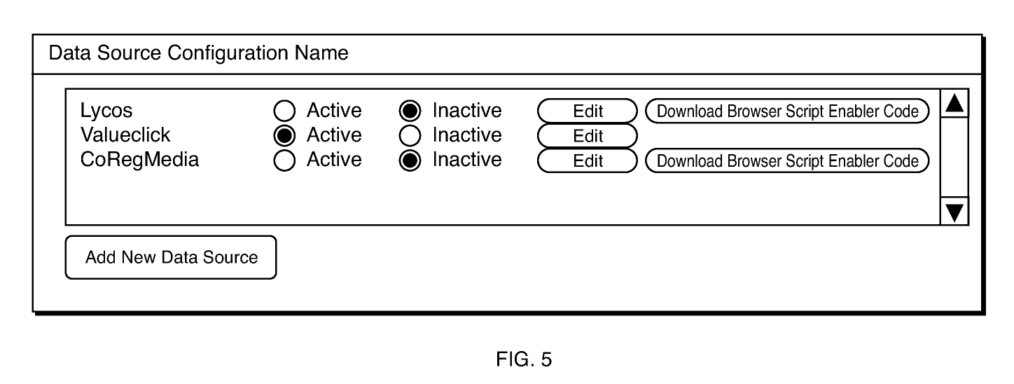

For a data source to initiate a new data source configuration or to edit an existing one, the data source accesses a web interface exposed by data source configurator 200 by clicking on a link to the web interface in a browser. In response, data source configurator 200 queries configuration data store 250 to retrieve all existing data source configurations set up by the data source previously (in accordance with any one of a number of methods that are well known to those of ordinary skill in the art), and data source configurator 200 displays this data as a list in the screen shown in FIG. 5 (in accordance with any one of a number of methods that are well known to those of ordinary skill in the art). As shown in the screen shown in FIG. 5, and in accordance with one or more embodiments, each data source configuration has a name, and a flag (“Active” or “Inactive”) used to indicate to data transfer engine 500 that the data source will send data according to the format and method specified by this data source configuration. In addition, as shown in the screen shown in FIG. 5, an “Edit” button is displayed next to each data source configuration (in accordance with any one of a number of methods that are well known to those of ordinary skill in the art) to allow the data source to edit the data source configuration. In addition, an “Add New Data Source” button is displayed to enable the data source to create a new data source configuration.

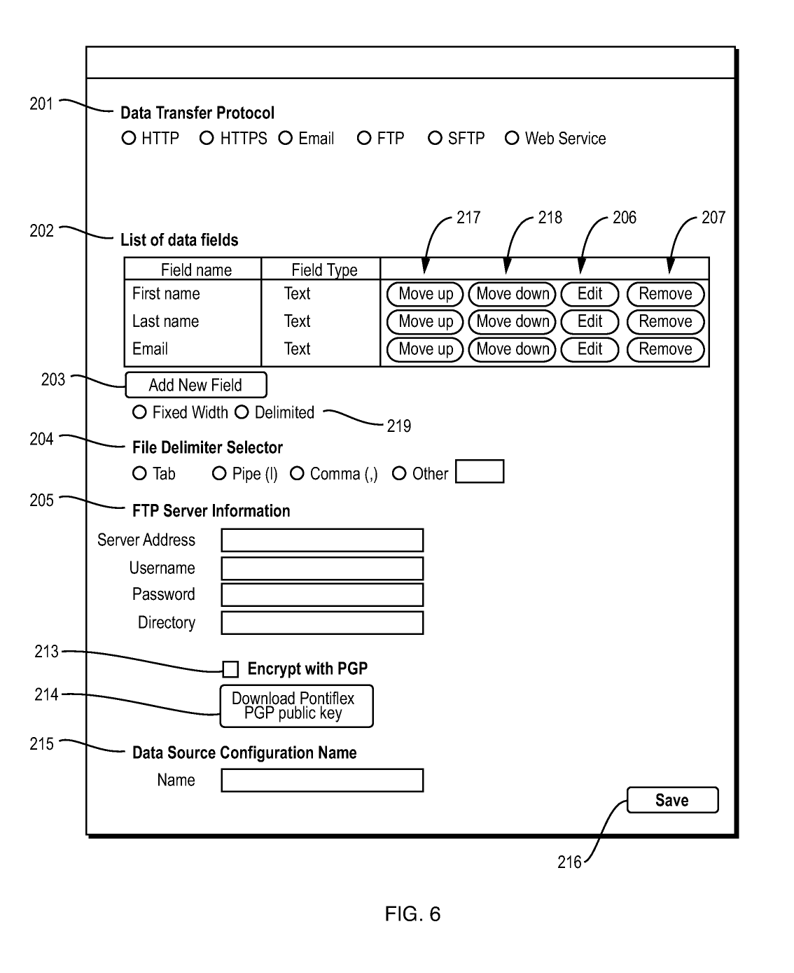

In response to the data source's clicking the “Edit” button on the screen shown in FIG. 5, in accordance with one or more embodiments, data source configurator 200 presents the screen shown in FIG. 6, pre-populated with the selected data source configuration information (in accordance with any one of a number of methods that are well known to those of ordinary skill in the art). In response to the data source's clicking the “Add New Data Source” button on screen shown in FIG. 5, in accordance with one or more embodiments, data source configurator 200 presents the screen shown in FIG. 6 (in accordance with any one of a number of methods that are well known to those of ordinary skill in the art). FIG. 6 illustrates an instance of a data source configuration with Data Transfer Protocol selector 201, List of data fields 202, “Add New Field” selector 203, File Delimiter Selector 204, optional FTP Server Information form 205, and Data Source Configuration Name form 206. Based on data source selection from Data Transfer Protocol selector 201, data source configurator 200 will conditionally display File Delimiter Selector 204 or FTP Server Information form 205. For example, if the data source selects HTTP or HTTPS from Data Transfer Protocol selector 201, File Delimiter Selector 204 and FTP Server Information form 205 are not displayed. However, if the data source selects FTP or SFTP from Data Transfer Protocol Selector 201, then File Delimiter Selector 204 and FTP Server Information form 205 are displayed.

Data Transfer Protocol selector 201 specifies the data transfer protocol that the data source will use to send data to computer system 1000. In accordance with one or more embodiments, data source configurator 200 displays a list of data transfer protocols (for example and without limitation, FTP, RCP, SFTP, SCP, HTTP, HTTPS, and SOAP via Web Service) from which the data source may choose. List of data fields 203 specifies the data fields that make up a single data record of the data transfer from the data source. In accordance with one or more embodiments, on the screen shown in FIG. 6, the data source will specify: (a) in case the data source selects FTP or Email for data transfer protocol, the required ordering of data fields (as shown in the screen shown in FIG. 6) within each row of data (in accordance with one or more embodiments, the data source specifies the ordering of data fields by clicking on “Move up” button 217 or “Move down” button 218); (b) data fields to be removed from List of data fields 202 by clicking on “Remove” button 207; and (c) whether to have data fields in fixed-width format or to have data fields be delimited by a chosen character using selector 219. If the data source chooses to use delimited data fields by selecting a “Delimited” option for selector 219 on the screen shown in FIG. 6, the data source will specify a delimiter character using File Delimiter Selector 204. File Delimiter Selector 204 specifies the delimiter character that will be used to separate the data fields. File Delimiter Selector 204 will be shown only if the data source elects to transfer data using FTP or SFTP or email data transfer protocols. The delimiter character can be, for example and without limitation, comma (,), tab (\t), pipe (|), or any other single character of its choice (in accordance with any one of a number of methods that are well known to those of ordinary skill in the art).

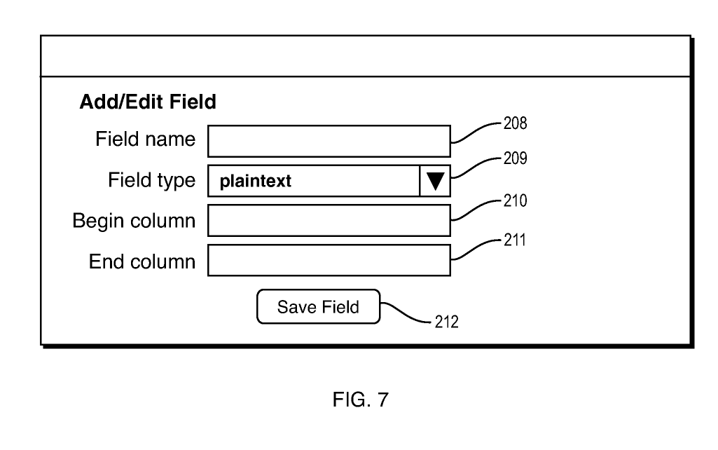

FTP Server Information form 205 includes the FTP server address, the FTP server data sourcename and password, and the FTP directory name that will be used by computer system 1000 to receive data from the data source if the data source elects to transfer data using FTP or SFTP. If the data source clicks on “Add New Field” button 203, data source configurator 200 displays the screen shown in FIG. 7.

To use the screen shown in FIG. 7, the data source will enter the field name Field name 208, and select a field type using Field type 209. If the data source chooses to use a fixed width format by selecting a “Fixed width” option from selector 219 on the screen shown in FIG. 6, data source configurator 200 will present a begin column number in Begin column 210 and an end column number in End column 211 for the new field on the screen shown in FIG. 7. After the data source clicks “Save field” button 212 on the screen shown in FIG. 7, data source configurator 200 adds the field name to the data source configuration, and the new field is displayed on List of data fields 202. If the data source clicks on “Edit” button 206 on the screen shown in FIG. 6, data source configurator 200 displays the screen shown in FIG. 7 pre-populated with the selected field name in Field name 208 and a field type in Field type 209. In addition, if the data source selects the “Fixed Width” option from selector 219 on the screen shown in FIG. 6, data source configurator 200 displays a begin column number in Begin column 210 and an end column number in End column 211 on the screen shown in FIG. 7. After the data source clicks on “Save field” button 212 on the screen shown in FIG. 7, data source configurator 200 stores the changes to the field, and the changes are reflected in List of data fields 202 on the screen shown in FIG. 6. In accordance with one or more embodiments, the data source can choose to send files securely by encrypting files with computer system 1000's public PGP key. To do this, the data source will click “Encrypt with PGP” checkbox 213 on the screen shown in FIG. 6, and click on “Download Pontiflex PGP public key” button 214. In response, the data source will download computer system 1000's public PGP key. In accordance with one or more embodiments, computer system 1000 will decrypt files sent by the data source using computer system 1000's PGP private key.

The data source enters a human-readable name in Data Source Configuration Name form 215 to identify the data source configuration in data source configurator 200. After entering the required information on the screen shown in FIG. 6, the data source clicks on “Save” button 216 to save the data source configuration to configuration data store 250.

In accordance with one or more embodiments, data source configurator 200 stores the data source configuration in machine-readable format (for example and without limitation, in XML or as normalized database tables) in configuration data store 250 (in accordance with any one of a number of methods that are well known to those of ordinary skill in the art). The data components comprising the data source configuration are set forth in detail in FIG. 12.

Data Transfer Section

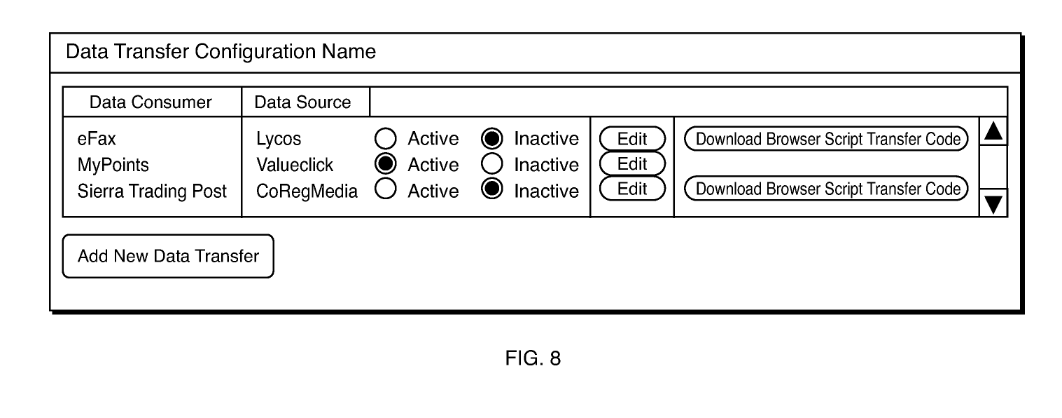

In accordance with one or more embodiments, data transfer configurator 300 is a module of computer system 1000 that exposes an interface, for example and without limitation, a web interface, wherein a user can set up a data transfer from a data source to a data consumer using a pre-existing data source configuration and data consumer configuration from configuration data store 250. In accordance with one or more embodiments, users will use this interface as a set up (for example, one-time set up) tool for each data transfer. A data transfer configuration will need to change only if the data source or the data consumer changes its respective configuration. In accordance with one or more embodiments, an interface (refer to FIG. 8) will display web pages where a user can view its current data transfer configurations, edit these data transfer configurations, and/or add new data transfer configurations.

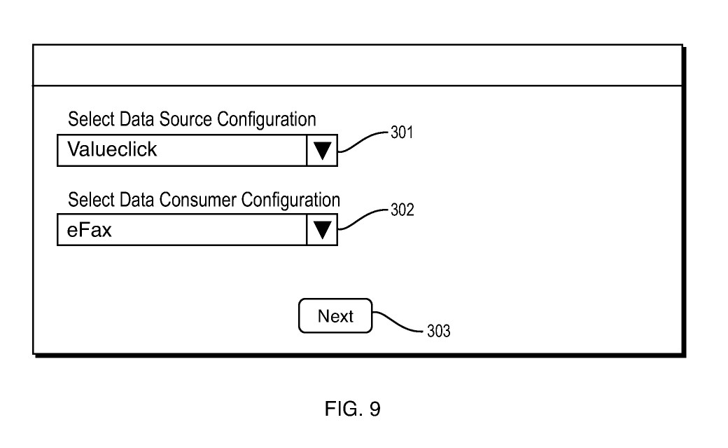

For a user to initiate a new data transfer configuration or to edit an existing one, the user accesses a web interface exposed by data transfer configurator 300 by clicking on a link to the web interface in a browser. In accordance with one or more embodiments, upon a user's initiating a new data transfer configuration, or editing an existing data transfer configuration, data transfer configurator 300 will present web forms requesting information. In accordance with one or more embodiments, first, data transfer configurator 300 displays a screen (refer to FIG. 9). The user selects a data source configuration from a “Select Data Source Configuration” list and selects a data consumer configuration from a “Select Data Consumer Configuration” list. Data transfer configurator 300 creates the “Select Data Source Configuration” list by listing all data source configurations in configuration data store 250 (in accordance with any one of a number of methods that are well known to those of ordinary skill the art). Data transfer configurator 300 creates the “Select Data Consumer Configuration” list by listing all data consumer configurations in configuration data store 250 (in accordance with any one of a number of methods that are well known to those of ordinary skill the art). After selecting a data source configuration and a data consumer configuration, the user clicks on a “Next” button on the screen.

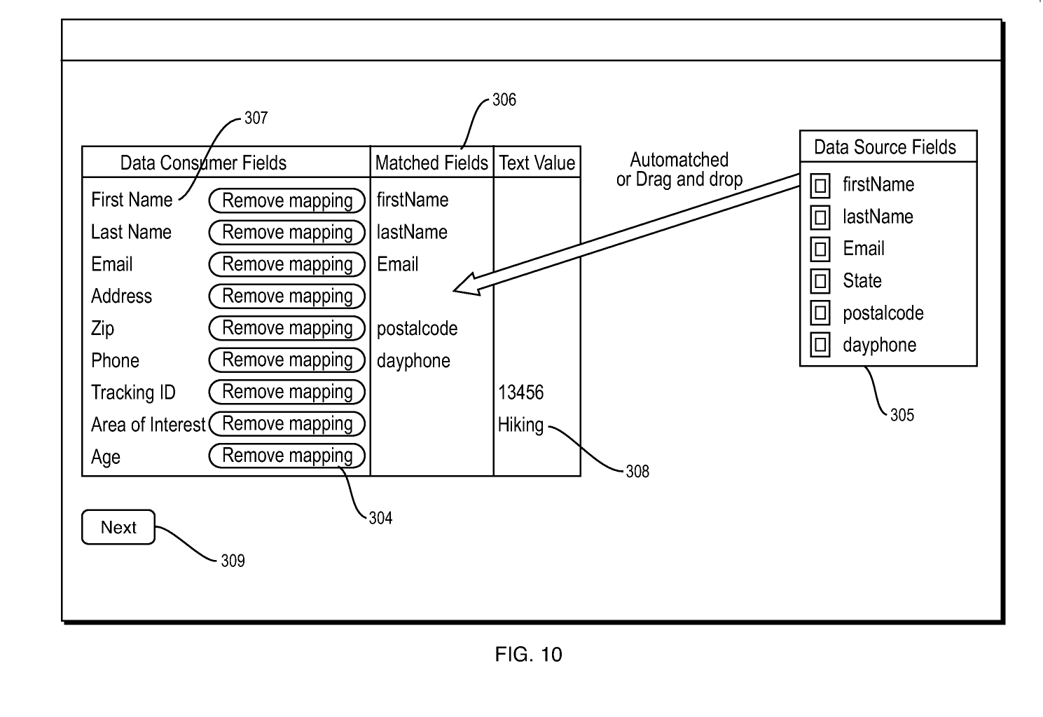

In accordance with one or more embodiments, whenever the user clicks on the “Next” button on the screen, data transfer configurator 300 will map each data field defined in the data consumer configuration selected on the screen to data fields defined in the data source configuration selected in the screen. Data transfer configurator 300 maps a data consumer field to a data source field by selecting the data source field name which best matches the data consumer field name using, for example and without limitation, established and existing implementations of approximate string matching algorithms (in accordance with any one of a number of methods that are well known to those of ordinary skill the art such as, for example and without limitation, those referenced at http://en.wikipedia.org/wiki/Approximate_string_matching and http://en.wikipedia.org/wiki/agrep, nrgrep, cgrep. After mapping data consumer fields to data source fields, the data transfer configurator 300 displays a screen (refer to FIG. 10) where the user can verify these mappings and modify them if required.

In accordance with one or more embodiments, data transfer engine 500 uses mappings defined on the screen to map data sent by the data source to data sent to the data consumer. In particular, it does this by using a value in the data source field and populating that value in a corresponding data consumer field. In the case where the data consumer field is mapped to a fixed text value instead of a data source field, the fixed text value is used to populate the data consumer field.

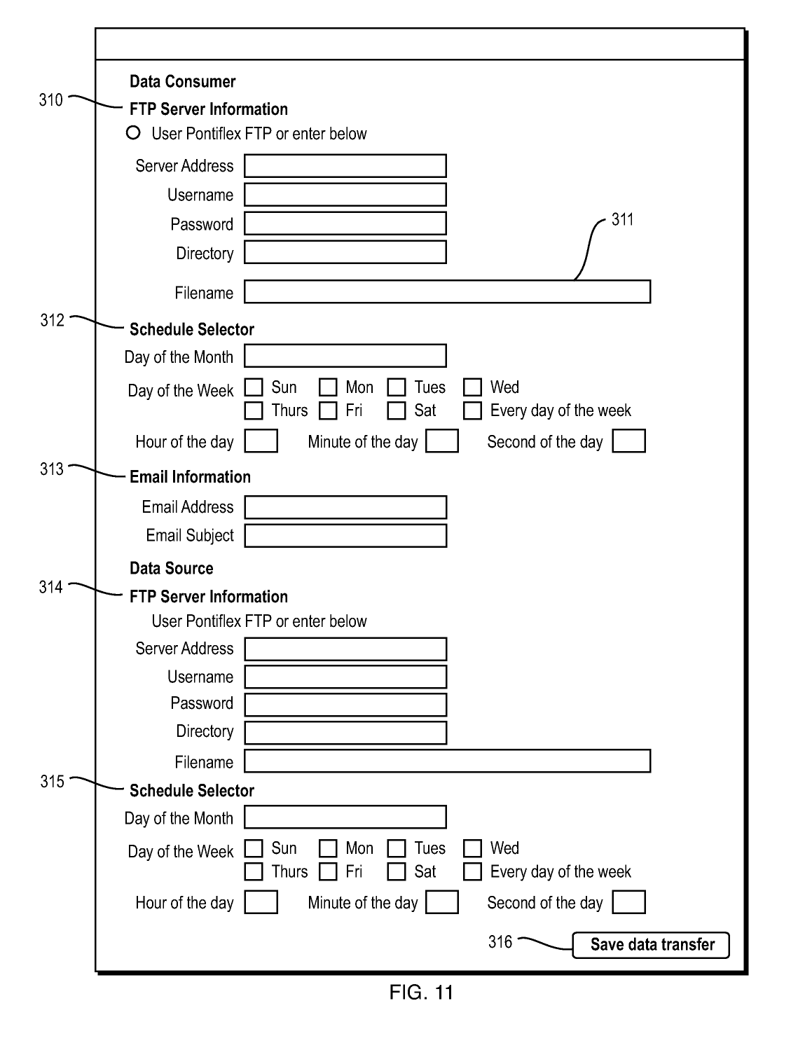

After the user clicks a “Next” button, data transfer configurator 300 presents another screen (refer to FIG. 11). If the data transfer protocol for the selected data consumer from “Select Data Consumer Configuration” list 302 is set up as FTP or SFTP, data transfer configurator 300 will show an FTP Server Information form—the values for the FTP Server Information form will be pre-populated from FTP Server Information from the data consumer configuration. In accordance with one or more such embodiments, the user can override this information by entering a different FTP server address, username, password and/or directory in the FTP Server Information shown on the screen. In addition, the user can also override this information by selecting to use an FTP server provided by computer system 1000. In this case, computer system 1000 will create an FTP username, password and directory in primary data store 600. If the data transfer protocol for the selected data consumer from “Select Data Consumer Configuration” list 302 is set up as FTP or SFTP or Email, data transfer configurator 300 will show a Filename form on the screen. Data transfer engine 500 will use the filename entered in this field to name the files used for the data transfers sent to the data consumer.

If the data transfer protocol for the selected data consumer from “Select Data Consumer Configuration” list 302 is set up as FTP or SFTP or Email, data transfer configurator 300 will show Schedule Selector form 312 wherein the user can specify a schedule in the form of day of month, day of week, and hour/minute/second of day. Data transfer configurator 300 will use the values entered in Schedule Selector form 312 to set up a transfer schedule in data transfer scheduler 400. Data transfer scheduler 400 will send the data transfer to the data consumer using data transfer engine 500 according to the specified schedule. If the data transfer protocol for the selected data consumer from “Select Data Consumer Configuration” list 302 is set up as Email, data transfer configurator 300 will show an Email Information form on the screen. The values for the Email Information form will be pre-populated with email information from the data consumer configuration. The user can override this information by entering a different email address and email subject in the Email Information form on the screen.

If the data transfer protocol for the selected data source from “Select Data Source Configuration” list 301 is set up as FTP or SFTP, data transfer configurator 300 will show an FTP Server Information form on the screen. The values for the FTP Server Information form will be pre-populated from FTP Server Information from the data source configuration. In accordance with one or more such embodiments, the user can override this information by entering a different FTP server address, username, password and/or directory in the FTP Server Information form shown on the screen. In addition, the user can also override this information by selecting to use an FTP server provided by computer system 1000. In this case, computer system 1000 will create an FTP username, password and directory in primary data store 600. If the data transfer protocol for the selected data source from “Select Data Source Configuration” list 301 is set up as FTP or SFTP, data transfer configurator 300 will show Schedule Selector form 315 wherein the user can specify a schedule in the form of day of month, day of week, and hour/minute/second of day. Data transfer scheduler 400 will pull data from the data source using data transfer engine 500 according to the specified schedule. Next, the user clicks a “Save data transfer” button and data transfer configurator 300 saves the data transfer configuration in configuration data store 250.

Finally, in accordance with one or more embodiments, data transfer configurator 300 stores the configuration in machine-readable format (for example and without limitation, in xml or as normalized database tables) in configuration data store 250 (in accordance with any one of a number of methods that are well known to those of ordinary skill in the art). The data components comprising the data transfer configuration is detailed in FIG. 14.

In accordance with one or more embodiments, data transfer scheduler 400 is a module of computer system 1000 that is used in the manner described below for data transfers that are set up to use an FTP, an SFTP or an Email data transfer protocol. According to the schedule specified during data transfer configuration, data transfer scheduler 400 will send data to a data consumer or pull data from a data source.

Data transfer scheduler 400 uses established and pre-existing implementations of job scheduling algorithms such as, for example and without limitation, Unix crontab or jcrontab.

Data transfer engine 500 handles the actual transfer of data from a data source to a data consumer (in accordance with any one of a number of methods that are well known to those of ordinary skill in the art). For a data transfer, a data transfer engine retrieves a data source configuration, a data transfer configuration, and a data consumer configuration from configuration data store 250. Data transfer engine 500 receives data from the data source, transforms the received data into a form required by the data consumer as specified in the data consumer configuration and data transfer configuration, and sends the transformed data to the data consumer. In accordance with one or more embodiments, a data transfer engine is capable of communicating in an open protocol such as, for example and without limitation, FTP, SFTP, RCP, SCP, HTTP, HTTPS, and SOAP.

In accordance with one or more embodiments, primary data store 600 is a module of computer system 1000 that is used when a data source or a data consumer chooses to send data to or receive data from, respectively, computer system 1000 using FTP, SFTP or Email data transfer protocols. In accordance with one or more embodiments, primary data store 600 comprises multiple data stores that are load-balanced (in accordance with any one of a number of methods that are well known to those of ordinary skill in the art). In accordance with one or more embodiments, the data stores of primary data store 600 expose one or more of an FTP, an SFTP, an SCP, an HTTP, an HTTPS, an SMTP, and a Web Service interface (in accordance with any one of a number of methods that are well known to those of ordinary skill in the art). In accordance with one or more embodiments, the interfaces will be exposed by using open source or third party proprietary software such as, for example and without limitation, proftpd (FTP), Apache web server (HTTP, HTTPS), and so forth. In addition, and in accordance with one or more embodiments, all of the data stores of primary data store 600 share a common authentication module for example and without limitation, openldap (LDAP) that is fabricated in accordance with any one of a number of methods that are well known to those of ordinary skill in the art. Advantageously, this enables the same authentication token to be used across multiple data stores in accordance with any one of a number of methods that are well known to those of ordinary skill in the art.

Further, in accordance with one or more embodiments, primary data store 600 can create separate, secure data areas for each data source and data consumer, and can auto-generate credentials in a common authentication module to access these data areas (in accordance with any one of a number of methods that are well known to those of ordinary skill in the art). The credentials are auto-generated during the data transfer configuration process if the user selects to use computer system 1000's FTP server for data transfer.

In accordance with one or more embodiments, where a data source chooses to send data to computer system 1000 via an HTTP or HTTPS data transfer protocol, the data source has an option to send the data to computer system 1000 using a BrowserScriptPost code snippet that will be generated by computer system 1000, and will be available to download by the data source via a computer system 1000-provided web interface (alternatively, computer system 1000 may provide the BrowserScriptPost code snippet by email or a user of computer system 1000 may cause the BrowserScriptPost code snippet to be downloaded). The BrowserScriptPost code snippet provides a mechanism for sending data records directly to computer system 1000, in real time, without the data source's having to write custom backend code. In essence, as will be described below, set up for this functionality involves inserting a few lines of, for example and without limitation, JavaScript into, for example and without limitation, the Success or Thank You page at the end of a deal process flow.

In accordance with one or more embodiments, a BrowserScriptPost code snippet is provided to a data source in a browser based scripting language. For example, where the data source is collecting data via HTML web forms, the BrowserScriptPost code snippet may be provided as a JavaScript code snippet. The data source will insert the BrowserScriptPost code snippet into its HTML web form so that it may be used after the data it is sending to computer system 1000 has been collected by the data source, for example, after a user registration or order form step has been completed. FIG. 15 shows an HTML source code view of a sample data source-owned HTML web page that includes a BrowserScriptPost code snippet that is fabricated in accordance with one or more embodiments. As shown in FIG. 15, the BrowserScriptPost code snippet comprises three components: (a) a first component, data object 901, is an object that contains data to be transferred to computer system 1000 that can be accessed by the browser scripting language; (b) a second component, component 902, is a function that converts data object 901 to a request for an image resource from computer system 1000; and (c) a third component, component 903, is a call to the function defined in component 902 that passes data object 901 as a parameter, thereby effectively sending data collected by the data source in data object 901 to computer system 1000 as part of the image request.

In accordance with one or more embodiments, where the BrowserScriptPost code snippet is provided as a JavaScript code snippet, data object 901 is a JavaScript object which is a collection of properties of key name and value pairs such as, for example and without limitation, data={name:“name_value”, email:“email_value”, zip:“zip_value”}. This JavaScript object is generated for the data source by computer system 1000 by populating the key names as the names of the fields defined by the data source in data source configurator 200 in List of data fields 202 on the screen shown in FIG. 6. The values for the keys will be the data collected by the data source that it wants to send to the data consumer via computer system 1000. The values will be populated by the data source in the JavaScript object using any technology such as, for example and without limitation, JSP, ASP, ASP.NET, PHP that the data source uses to generate the data source's HTML web pages.

In accordance with one or more embodiments, where the BrowserScriptPost code snippet is provided as a JavaScript code snippet, the JavaScript function of component 902 reads the JavaScript object of component 901, and constructs (using any one of a number of methods that are well known to those of ordinary skill in the art) and adds a request for an image file from computer system 1000 to the data source's HTML web page. FIG. 16 shows pseudo code describing the JavaScript function of component 902. The request for the image file resource is constructed as an HTTP GET request with the key and value pairs of the JavaScript object of component 901 added in as parameters to the HTTP GET request. In addition to these GET parameters, a data transfer id identifying the data transfer configuration is also passed as a parameter to the JavaScript function of component 902. This data transfer id is also added as a parameter to the HTTP GET request. The data collected by the data source is thus passed on to computer system 1000 for onward transfer by computer system 1000 to the data consumer specified in the data transfer configuration.

In accordance with one or more embodiments, the data source can download the JavaScript for components 901 and 902 for each data source configuration set up using data source configurator 200 by clicking on the “Download Browser Script Enabler Code” button as shown on the screen shown in FIG. 5.

In accordance with one or more embodiments, where the BrowserScriptPost code snippet is provided as a JavaScript code snippet, component 903 is a call to the JavaScript function defined by component 902, which function accepts, as parameters, the data transfer id and the JavaScript object created by component 901, for example, send (123345, data). In accordance with one or more such embodiments, computer system 1000 will provide an instance of the JavaScript code to the data source for component 903 for each data transfer defined in data transfer configurator 300 that has been configured to accept data from the data source. The data source can download an instance of component 903 for each data transfer configuration by clicking on a “Download Browser Script Transfer Code” button on a screen provided. The unique data transfer id identifying the data transfer is generated by computer system 1000 on creation of a new data transfer configuration, and will be populated by computer system 1000 in each instance of the Java Script code snippet for component 903. For each instance where the data source wants to send collected data in component 901 to computer system 1000, the data source will place calls to the JavaScript function on the web page after placing the JavaScript code for component 901 and 902 using any technologies such as, for example and without limitation, JSP, ASP, ASP.NET, PHP that the data source uses to generate data source's HTML web pages.

Based on the examples given above for component 901 and 903, the HTTP GET request for an image resource from computer system 1000 will be constructed by component 902 as: https://pontiflex.com/scriptpost?transferid=123345&name=name_value&email=email_value&zip=zip_value.

The image resource request that will be added to the data source's HTML web page will be added as an HTML image tag that will look like <img src=“https://pontiflex.com/scriptpost?transferid=123345&name=name_value&email=email_value&zip=zip_value”/>.

In accordance with one or more embodiments, archiver 800 runs at a system-defined archival time interval, and moves data; older than the archival time interval, from primary data store 600 to an archival data warehouse of archiver 800 (in accordance with any one of a number of methods that are well known to those of ordinary skill in the art).

What is claimed is:

1. A method for displaying offers in a banner Ad Unit which comprises:
obtaining multiple Advertisers' offers that are stored in a database;
displaying the multiple Advertisers' offers in a single banner Ad Unit in a web browser at a Publisher's site to a consumer;
determining which of the offers the consumer has selected;
displaying a data entry form in the Ad Unit;
obtaining data input by the consumer; and
forwarding the consumer data to Advertisers associated with the selected offers.

2. The method of claim 2 further comprising:
obtaining one or more further Advertiser offers from the database;
displaying the one or more further Advertiser offers in the Ad Unit;
determining which of the further offers the consumer has selected; and
forwarding the consumer data to Advertisers associated with the selected offers.

3. The method of claim 1 wherein displaying a data entry form further comprises;
displaying the offers in the Ad Unit with a scroll bar.

4. The method of claim 2 wherein obtaining data input by the consumer further comprises:
displaying a message to the consumer in the Ad Unit; and
hiding selected offers.

5. The method of claim 3 further comprises:
obtaining one or more further Advertiser offers from the database;
displaying the one or more further Advertiser offers in the Ad Unit;
determining which of the further offers the consumer has selected; and
forwarding the consumer data to Advertisers associated with the selected offers.

6. The method of claim 1 wherein obtaining data input by the consumer comprises:
validating data input by the consumer.

7. The method of claim 1 wherein forwarding comprises:
forwarding the consumer data and offer information to a data bridge.

8. The method of claim 2 wherein obtaining one or more further Advertiser offers comprises:
obtaining one or more further offers from the database using information obtained from selected offers.

9. The method of claim 5 wherein obtaining one or more further Advertiser offers comprises:
obtaining one or more further offers from the database using information obtained from selected offers.

10. The method of claim 1 wherein the Ad Unit is a Tower Ad Unit.

11. The method of claim 1 wherein the Ad Unit is a Square Ad Unit.

12. The method of claim 1 which further comprises:
obtaining Advertiser information for an offer; and
creating and storing an Advertiser's offer in the database.
